(19) United States
(12) Patent Application Publication
(10) Pub. No.: US 2012/0233419 A1
(43) Pub. Date: Sep. 13, 2012

(54) COMPUTER SYSTEM, METHOD OF SCHEDULING DATA REPLICATION, AND COMPUTER-READABLE NON-TRANSITORY STORAGE MEDIUM

(75) Inventor: Tatsuro Yamashita, Yokohama (JP)

(73) Assignee: Hitachi, Ltd.

(21) Appl. No.: 13/133,864

(22) PCT Filed: Mar. 9, 2011
(86) PCT No.: PCT/JP2011/055534

§ 371 Date: Jun. 9, 2011

(51) Int. Cl. G06F 12/16

(52) U.S. Cl. 711/162; 711/E12.103

(57) ABSTRACT

An embodiment of this invention schedules data replications for backing up a first storage system providing a plurality of applications with volumes to a second storage system. This scheduling determines scheduled finish times of respective data replications for the plurality of applications and determines start times of the respective data replications for the plurality of applications from the scheduled finish times of the respective data replications and the respective amounts of data to be transferred for the plurality of applications, using a data transfer rate between the storage systems and an overlap degree of data replication periods of the plurality of applications.

### TECHNICAL FIELD

This invention relates to a computer system, a method of scheduling data replication, and a computer-readable non-transitory storage medium and, in particular, relates to data replication scheduling for backing up for a plurality of applications.

### BACKGROUND ART

In a computer system including a host computer on which application programs (hereinafter, applications) run and a storage system, the storage system provides a part of its storage area to the applications for areas to be used (volumes). The applications access the provided volumes (read data or write data) to perform a variety of processing.

The computer system backs up volumes (primary volumes) to prepare for data corruption caused by some failure. The computer system restores a volume with the data stored in the copied volume (secondary volume) to recover from the failure. Through this operation, applications can continue to execute jobs and other kinds of processing in the same way as before the occurrence of failure.

To prevent routine work from being affected, a backup job is required to be finished within the time period specified by a user. For this reason, a method is employed that estimates the time required for a data replication from the difference between the primary volumes and the secondary volumes and a data transfer rate. Moreover, the patent literature 1 discloses a method of obtaining a backup of applications while creating a backup schedule based on the importance of backup target data and the reliability of a storage apparatus storing the data and estimating the processing time for the backup job.

The patent literature 2 discloses a technique that reallocates data by a specified due date in the case where a plurality of tasks to reallocate data stored in volumes in a storage system are planned.

This technique calculates, in migrating data stored in a volume to another, required time for migrating the data based on the amount of data to be migrated and configuration information on the volume storing the data to be migrated and the volume of the migration destination, to create a volume migration plan. If the time for carrying out the created volume migration plan overlaps with the time for carrying out an existing volume migration plan, the volume migration plan with a higher priority is performed first.

### CITATION LIST

### Patent Literature

### [PTL 1] JP 2008-84327 A

### [PTL 2] JP 2008-203937 A

### SUMMARY OF INVENTION

### Technical Problem

With recent expansion of cloud service market, it is expected that the necessity for backing up volumes for a plurality of applications within the same time period will increase. However, neither of the above-described techniques can meet this requirement properly.

In backing up volumes for a plurality of applications in the same time period, it is more likely that data replication cannot be finished by the time the backup job must be finished (absolute finish time of backup job) in both of the above-described techniques, because of lowered data transfer rates allocated to the individual application data.

Moreover, in the both of the above-described techniques, data replication is likely to be finished considerably earlier than the absolute finish time of the backup job. If data replication finishes too early, the total amount of data transferred for the backup job increases. This is because, if the period from the finish of data replication to the absolute finish time of the backup job is long, the primary volumes may be changed after the data replication so that a new data copy (data transfer) to the secondary volumes is more likely to be required. Consequently, the total amount of data to be transferred will increase.

Accordingly, a technique is desired that achieves proper scheduling for backing up volumes for a plurality of applications.

### Solution to Problem

An embodiment of the present invention is a computer system comprising a first storage system for providing a plurality of applications with volumes; a second storage system which is coupled to the first storage system and stores backup volumes of the volumes; and a management system which is coupled to the first storage system and the second storage system and schedules data replications of the volumes. The management system determines respective scheduled finish times of data replications for the plurality of applications. The management system determines individual start times of the data replications for the plurality of applications from the respective scheduled finish times of data replications and respective amounts of data to be transferred for the plurality of applications, using a data transfer rate between the first storage system and the second storage system and an overlap degree of data replication periods of the plurality of applications.

### Advantageous Effects of Invention

This invention achieves proper scheduling of volume backups for a plurality of applications.

### BRIEF DESCRIPTION OF DRAWINGS

[FIG. 1]

FIG. 1 is a block diagram illustrating an outline configuration of a computer system in an embodiment.

[FIG. 2]

FIG. 2 is a diagram illustrating backup scheduling for two applications in an embodiment.

[FIG. 3]

FIG. 3 is a block diagram schematically illustrating a configuration of a client in an embodiment.

[FIG. 4]

FIG. 4 is a block diagram schematically illustrating a configuration of a business host server in an embodiment.

[FIG. 5]

FIG. 5 is a block diagram schematically illustrating a configuration of a management server in an embodiment.

[FIG. 6]

FIG. 6 shows an example of a screen image of a schedule table for a backup schedule in an embodiment.

[FIG. 7A]

FIG. 7A is a diagram illustrating scheduling calculation of data replications in an embodiment.

[FIG. 7B]

FIG. 7B is a diagram illustrating scheduling calculation of data replications in an embodiment.

[FIG. 7C]

FIG. 7C is a diagram illustrating scheduling calculation of data replications in an embodiment.

[FIG. 7D]

FIG. 7D is a diagram illustrating scheduling calculation of data replications in an embodiment.

[FIG. 7E]

FIG. 7E is a diagram illustrating scheduling calculation of data replications in an embodiment.

[FIG. 7F]

FIG. 7F is a diagram illustrating scheduling calculation of data replications in an embodiment.

[FIG. 8]

FIG. 8 shows an example of a screen image of a schedule table for a backup schedule in an embodiment.

[FIG. 9]

FIG. 9 is a diagram illustrating scheduling recalculation of data replications in an embodiment.

[FIG. 10]

FIG. 10 is a diagram illustrating a method of selecting applications to coordinate the data replication periods in scheduling recalculation of an embodiment.

[FIG. 11A]

FIG. 11A is a diagram illustrating scheduling recalculation of data replications in an embodiment.

[FIG. 11B]

FIG. 11B is a diagram illustrating scheduling recalculation of data replications in an embodiment.

[FIG. 11C]

FIG. 11C is a diagram illustrating scheduling recalculation of data replications in an embodiment.

[FIG. 11D]

FIG. 11D is a diagram illustrating scheduling recalculation of data replications in an embodiment.

[FIG. 11E]

FIG. 11E is a diagram illustrating scheduling recalculation of data replications in an embodiment.

[FIG. 11F]

FIG. 11F is a diagram illustrating scheduling recalculation of data replications in an embodiment.

[FIG. 11G]

FIG. 11G is a diagram illustrating scheduling recalculation of data replications in an embodiment.

[FIG. 11H]

FIG. 11H is a diagram illustrating scheduling recalculation of data replications in an embodiment.

[FIG. 11I]

FIG. 11I is a diagram illustrating scheduling recalculation of data replications in an embodiment.

[FIG. 12]

FIG. 12 shows an example of a screen image of a schedule table for a backup schedule in an embodiment.

[FIG. 13]

FIG. 13 shows an example of a screen image of a schedule table for a backup schedule in an embodiment.

[FIG. 14A]

FIG. 14A is a flowchart of scheduling of an embodiment.

[FIG. 14B]

FIG. 14B is a flowchart of scheduling of an embodiment.

[FIG. 14C]

FIG. 14C is a flowchart of scheduling of an embodiment.

[FIG. 15]

FIG. 15 is a diagram illustrating an example of a difference history table in an embodiment.

[FIG. 16]

FIG. 16 is a diagram illustrating an example of a difference management table in an embodiment.

[FIG. 17]

FIG. 17 is a diagram illustrating an example of a performance history table in an embodiment.

[FIG. 18]

FIG. 18 is a diagram illustrating an example of a performance table in an embodiment.

[FIG. 19]

FIG. 19 is a diagram illustrating an example of a schedule management table in an embodiment.

[FIG. 20]

FIG. 20 is a diagram illustrating an example of distribution of data transfer rate between storages in a specific time slot in an embodiment.

### DESCRIPTION OF EMBODIMENTS

Hereinafter, an embodiment of this invention will be described with reference to the accompanying drawings. For clarity of explanation, the following descriptions and the accompanying drawings contain omissions and simplifications as appropriate. Throughout the drawings, like components are denoted by like reference signs and their repetitive explanation is omitted for clarity of explanation, if not necessary.

This embodiment performs backup scheduling (data replication scheduling) of volumes provided for a plurality of application programs (hereinafter, applications). This embodiment determines the individual scheduled finish times of data replications for the plurality of applications and determines the start times of the data replications for individual application data (data in one or more volumes allocated to each application) based on the scheduled finish times of data replications.

This embodiment calculates a period length of data replication for each application from the data transfer amount in the data replication for each application and the data transfer rate allocated to each application in each time slot. The data transfer rate allocated to each application is calculated using an overlap degree of the applications subjected to data replication in each time slot. This embodiment calculates a start time of a data replication from a predetermined finish time of the data replication and a calculated period length of the data replication.

Determining the start time of data replication with reference to the scheduled finish time of data replication achieves reduction in the difference between the actual finish time of data replication and the intended finish time. Moreover, calculating the data transfer rate to be allocated to each application using the overlap degree of the applications in each time slot achieves calculation of more precise start time of data replication and reduction of the difference between the scheduled finish time of data replication and the actual finish time.

In a preferred configuration, this embodiment presets an allowable start time of data replication for a backup job to each application. If the determined start time of data replication is earlier than the allowable start time of data replication, this embodiment reschedules (recalculates the schedule for) the backup job. This configuration achieves data replication in the hours when the data replication causes less effect to the other jobs.

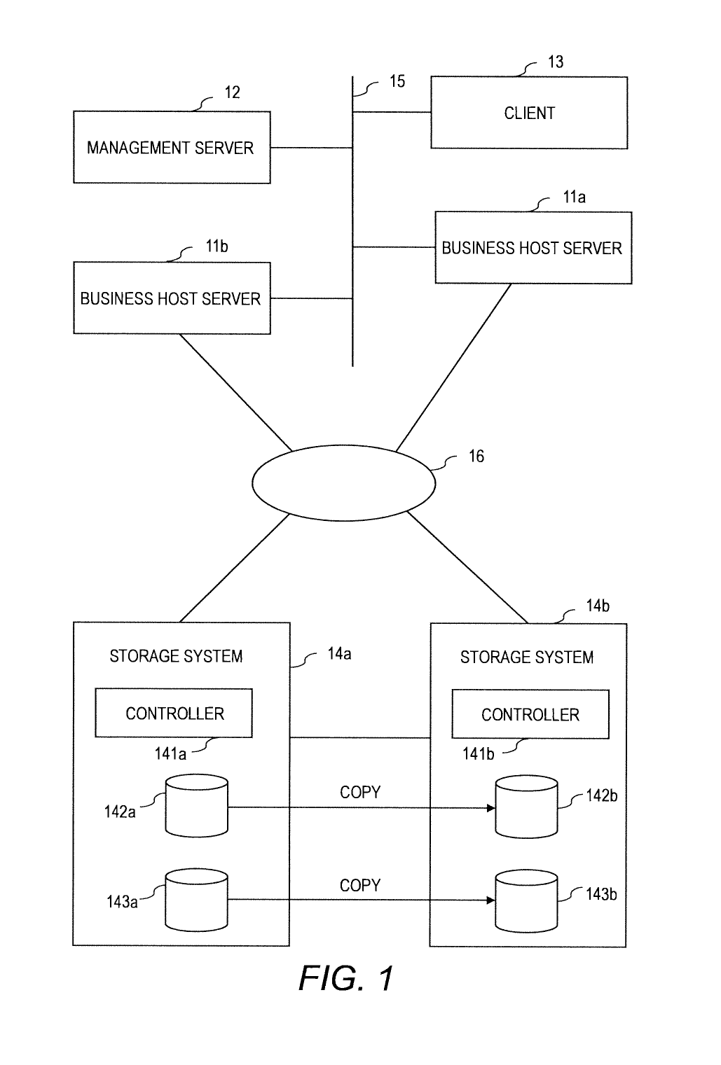

FIG. 1 is a block diagram schematically illustrating an outline configuration of a computer system in this embodiment. This computer system comprises business host servers 11a and 11b, a management server 12, a client 13, and storage systems 14a and 14b. The business host servers 11a and 11b, the management server 12, and the client 13 are computers. The business host servers 11a and 11b, the management server 12, and the client 13 are coupled via a management network 15 so that they can communicate with one another. In this configuration, the management network 15 is an IP network. It should be noted that the management network 15 may be a network other than the IP network as long as it is a network for data communication.

The business host servers 11a and 11b and the storage systems 14a and 14b are coupled via a data network 16. The data network 16 is a network for data communication and is a SAN (Storage Area Network) in this configuration. The data network 16 may be any network other than the SAN as long as it is a network for data communication.

The storage system 14a provides business applications in the business host servers 11a and 11b with volumes 142a and 143a, respectively. The volumes 142a and 143a are primary volumes. The storage system 14b includes volumes 142b and 143b. The volumes 142b and 143b are secondary volumes and configure copy pairs with the volumes 142a and 143a, respectively. The controllers 141a and 141b perform processing to the copy pairs such as creation of a copy pair and data replication in accordance with instructions from the business host servers 11a, 11b, or the management server 12.

A data backup replicates data from the primary volumes 142a and 143a to the secondary volumes 142b and 143b between the storage systems 14a and 14b coupled via the network 16. Typically, the data updated in the primary volumes 142a and 143a are replicated to the secondary volumes 142b and 143b.

The business host servers 11a, 11b, or the management server 12 instructs the storage systems 14a and 14b to replicate data (create a copy pair) before obtaining backup data and splits the copy pair upon obtaining the backup data. The computer which instructs data replication or another computer performs necessary processing, for example, verification, to the obtained backup data. In this embodiment, the processing after obtaining the backup data is not the point; accordingly, explanations thereon are omitted.

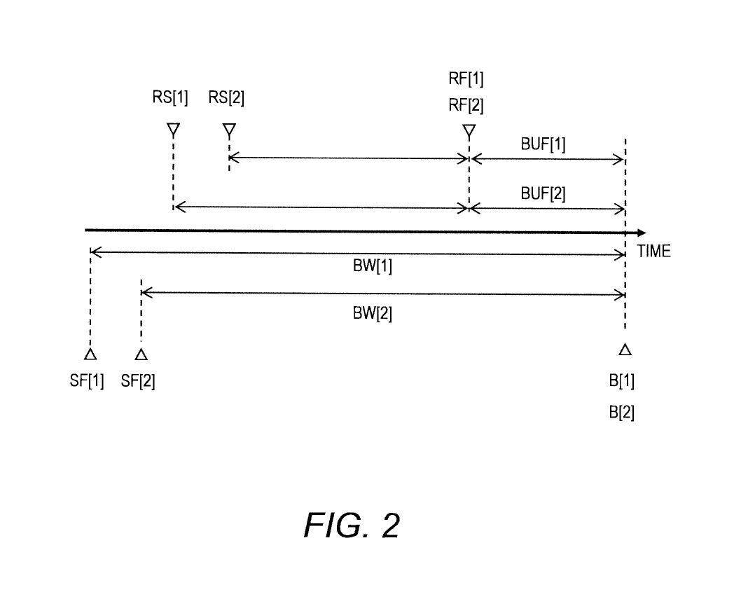

Next, with reference to FIG. 2, the meanings of the terms used in the backup scheduling of this embodiment will be explained. FIG. 2 is a diagram illustrating backup scheduling for two applications, an application 1 and an application 2. FIG. 2 schematically illustrates operation times and periods in a backup job on a time axis. The numeric characters in parenthesis indicate that the times or periods are for the application 1 or 2.

In FIG. 2, “SF” represents an allowable start time of a data replication. The allowable start time of data replication (SF) is the start time of a time slot in which the capability of the storage systems can be used to obtain a backup. Typically, it is the start time of the hours with less working load. If the backup data is secondarily used and the medium containing the backup data is overwritten with the next backup data, the finish time of the secondary use of the backup data should be taken into consideration.

Typically, the allowable start time of data replication is preliminarily specified by the user. The backup scheduling in this embodiment uses this time as an invariable and does not change it as long as the user makes a change to it.

“B” represents a backup acquisition time. At the backup acquisition time (B), the system temporarily stops the application database to obtain backup data. The system must finish a data replication by the backup acquisition time and the backup acquisition time is the absolute time to finish the data replication.

The backup acquisition time is preliminarily specified by the user. The backup scheduling in this embodiment uses this time as an invariable and does not change it as long as the user makes a change to it. The time period from the allowable start time of data replication (SF) to the backup acquisition time (B) is a backup window (BW).

“RF” represents a scheduled finish time of a data replication. The scheduled finish time of data replication (RF) is a predetermined scheduled value of the time when the data replication ends. If all of the copy pairs held by the backup target application have been synchronized, the data replication for the application is regarded as being finished.

“BUF” represents a buffering period between the scheduled finish time of data replication (RF) and the backup acquisition time (B). The backup scheduling sets the scheduled finish time of data replication (RF) at a time earlier than the backup acquisition time (B). However, the actual finish time of data replication differs from the scheduled finish time of data replication (this will be described later). The buffering period absorbs the difference between these times.

The user preliminarily specifies the buffering period (BUF) and the system makes a schedule so that the scheduled finish time of data replication (RF) is the same as or earlier than the time (the specified finish time of data replication) which is determined by deducting the buffering period (BUF) from the backup acquisition time (B). The specified finish time of data replication is the finish time of data replication which is intended by the user. In the backup schedule, it is most preferable that the scheduled finish time of data replication (RF) is the same as the specified finish time of data replication.

The user does not need to use the buffering period but may specify the backup acquisition time (B) at an earlier time by a desired buffering period. In such a case, the specified finish time of data replication (the ideal time of the scheduled finish time of data replication (RF)) is the same as the backup acquisition time (B). This system may use a given buffering period in the system, which is not specified by the user.

“RS” represents a start time of a data replication. The storage systems 14a and 14b start a data replication for a backup job at this time. The start time of data replication (RS) must be the same as or later than the allowable start time of data replication (SF). The period from the start time of data replication (RS) to the scheduled finish time of data replication (RF) is a data replication period.

The scheduling of this embodiment refers to the allowable start time of data replication (SF) and the backup acquisition time (B) specified by the user to each application and the amount of data to be transferred for the backup job the management server 12 obtains from the storage system 14a, and calculates the start time (RS) of data replication for each application.

In this calculation, the scheduling of this embodiment determines an overlap degree (a value of an overlap condition in each time slot) in transferring data of a plurality of applications and calculates a data transfer rate (a value of allocated data transfer rate in each time slot) to be allocated to each application data using the overlap degree. A data replication period length is calculated from the data transfer amount and the allocated data transfer rate. Details of a method of calculating the start time of data replication (RS) will be described later.

In the example of FIG. 2, if the scheduled finish time of data replication (RF) is later than the backup acquisition time (B), the job of data replication is delayed into the time slot with priority given to business activities, so that the backup acquisition operation adversely affects the business operations. Usually, business operations have higher priority than a backup job, the system terminates (aborts) the backup job in the middle of the processing. Namely, acquisition of the backup data is failed. It is important that backup scheduling determine the start times of data replications so that the data replication of each application will finish by the backup acquisition time for the application.

Next, state change of a copy pair during business hours and a backup job will be described. Explanations will be given to the copy pair of the volumes 142a and 142b in FIG. 1 by way of example. The business host server 11a stores created application data (data of a business application) to the primary volume 142a in the storage system 14a.

In time slots when where business operation (application) is performed in the business host server 11a, the volumes 142a and 142b forming a copy pair is in a Split state. In the Split state, data (update data) written to the primary volume 142a is not replicated to the secondary volume 142b.

After the business operation is finished, the management server 12 or the business host server 11a issues a Resync command for the copy pair to the storage system 14a and the controller 141a in the storage system 14a cooperates with the controller 141b in the storage system 14b to write the data in the primary volume 142a into the secondary volume 142b (Copying state).

When the data in the primary volume 142a are synchronized with the data in the secondary volume 142b (the secondary volume 142b has the same contents as the primary volume 142a), the copy pair becomes in a Pair state. In this embodiment, the time when the copy pair becomes in a Pair state is the finish time of data replication.

If a copy pair is in a Split state, data written in the primary volume 142a is not reflected to the secondary volume 142b. To reflect the data to the secondary volume 142b, the system performs a Resync operation to the copy pair to change the copy pair into a Copying state.

The copy pair stays in a Split state until the start time of data replication (RS). If the secondary volume 142b has backup data obtained previously and the secondary volume 142b is in use and the copy pair is changed into a Copying state, the previously obtained backup data is overwritten. For this reason, the operation to change the state into a Copying state (Resync operation) must not be performed prior to the allowable start time of data replication (SF).

When the copy pair turns from the Split state into a Copying state, the storage system 14a transfers the data (data of the differences) at the location where a data write is made in the primary volume 142a to the secondary volume 142b (the storage system 14b). The copy pair in the Copying state turns into a Pair state when the data in the primary volume 142a has been synchronized with the secondary volume 142b.

The management server 12 or the business host server 11a issues a Resync command to the copy pair at the start time of data replication (RS) and the copy pair turns to a Copying state. During a data replication, the copy pair is in the Copying state.

When the copy pair turns from the Copying state to a Pair state, the data in the primary volume 142a becomes in a state synchronized with the data in the secondary volume 142b. If the copy pair is in the Pair state at the backup acquisition time (B), the backup can be obtained on-line. The time when the copy pair turns into the Pair state is the finish time of data replication.

If a Pair state continues a long time for a copy pair, the amount of data to be transferred (from the time when they become in the Pair state to the backup acquisition time) increases. In a Pair state, every time the primary volume is written, the information is transferred to the secondary volume. If the same area is rewritten many times, the information is transferred every time. If a copy pair is in a Split state, information is transferred to the secondary volume only once when the copy pair turns to a Pair state. Accordingly, as the Pair state continues longer, the data transfer amount between the primary volume and the secondary volume increases.

Even if a copy pair changes from a Pair state to a Split state and another Resync command is issued to the copy pair, it is the same that the total data transfer amount increases if a new change is made to the data after the data in the copy pair become the same (a data replication has finished).

Returning the copy pair to the Pair state immediately before the backup acquisition time is not efficient since another scheduling is necessary. Accordingly, it is important that the finish time of data replication caused by a Resync command be as close as possible to the backup acquisition time. The method of this embodiment is particularly suitable to a system where a copy pair shows the above-described changes in state, but is applicable to any other system where a copy pair shows different changes in state.

In this system, a user operates the client 13 to instruct the management server 12 to schedule a backup job. The management server 12 obtains necessary information from the client 13, the business host servers 11a and 11b, and the storage systems 14a and 14b to schedule the backup job. The storage systems 14a and 14b execute the backup job (data replication) in a copy pair in accordance with the determined schedule.

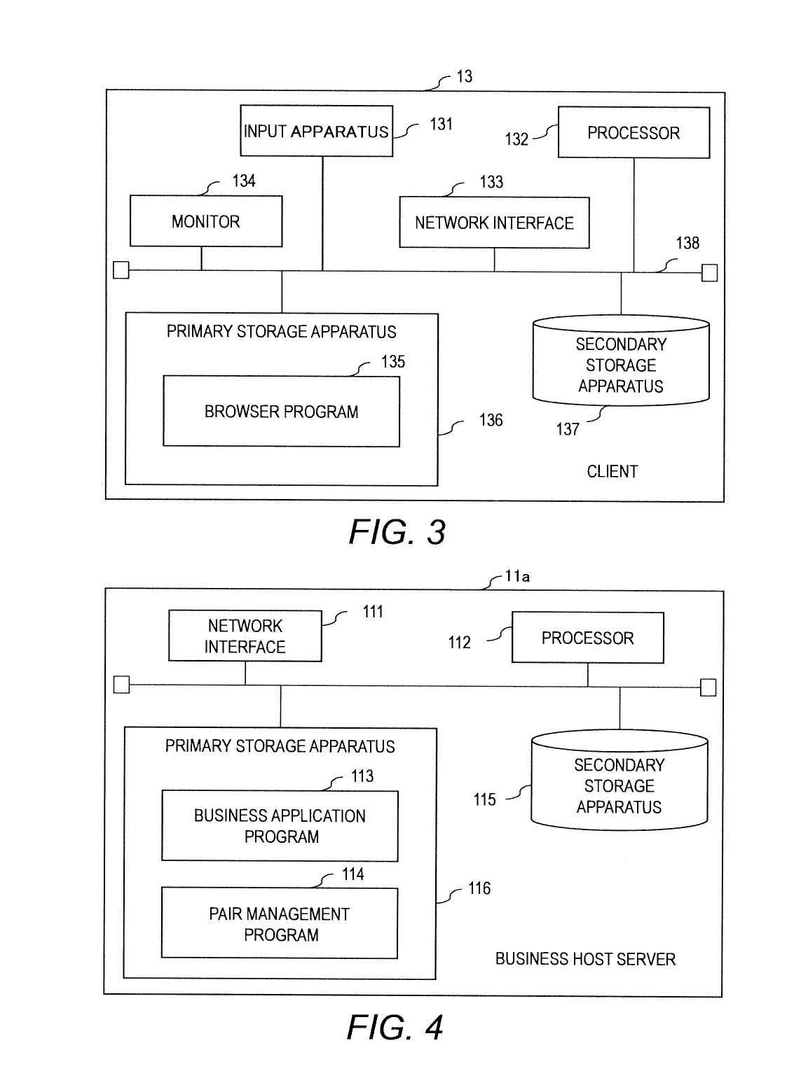

FIG. 3 is a block diagram schematically illustrating a configuration of the client 13. The client 13 is a computer and comprises an input apparatus 131, a processor 132, a network interface 133, a monitor 134, a primary storage apparatus 136, and a secondary storage apparatus 137, which are coupled with a bus 138 to be able to communicate with one another.

The client 13 communicates with the other computers in the network 15 via the network interface 133. A user inputs necessary information with the input apparatus 131 (such as a mouse and a keyboard) and can see necessary information with the monitor 134.

The processor 132 executes programs stored in the primary storage apparatus 136 to provide predetermined functions of the client 13. The primary storage apparatus 136 stores programs to be executed by the processor 132 and data required for execution of the programs. The programs include an OS (Operating System) not shown in the drawing and a browser program 135. The processor 132 may include a plurality of chips or a plurality of packages.

For convenience of explanation, the browser program 135 is shown within the primary storage apparatus 136, but typically, the programs are loaded from the secondary storage apparatus 137 to the primary storage apparatus 136. The secondary storage apparatus 137 is a storage apparatus including a non-volatile non-transitory storage medium for storing programs and data required to provide predetermined functions of the client 13. The secondary storage apparatus 137 may be an external storage apparatus coupled via a network.

The user accesses other computers using the browser program 135. In this embodiment, the user inputs information necessary for backup scheduling with the input apparatus 131 through the browser program 135 to transmit it to the management server 12. The monitor 134 displays the result of scheduling calculated by the management server 12. The user may operate the management server 12 with the input and output apparatus of the management server 12.

Next, with reference to FIG. 4, a configuration of the business host server 11a and 11b will be described. The business host servers 11a and 11b have the same configuration; hereinbelow, the configuration of the business host server 11a will be described. FIG. 4 is a block diagram schematically illustrating a configuration of the business host server 11a. The business host server 11a is a computer which accesses the resources of the storage systems 14a and 14b to perform tasks.

The business host server 11a comprises a network interface 111, a processor 112, a secondary storage apparatus 115, and a primary storage apparatus 116. These are coupled with a bus to be able to communicate with one another. The processor 112 executes programs stored in the primary storage apparatus 116 to provide predetermined functions of the business host server 11a. The primary storage apparatus 116 stores programs to be executed by the processor 112 and data required for execution of the programs. The programs include a business application 113 and a pair management program 114 in addition to an OS not shown in the drawing. The processor 112 may include a plurality of chips or a plurality of packages.

Typically, the programs are loaded from the secondary storage apparatus 115 to the primary storage apparatus 116. The secondary storage apparatus 115 is a storage apparatus including a non-volatile non-transitory storage medium for storing programs and data required to provide predetermined functions of the business host server 11a. The secondary storage apparatus 115 may be an external storage apparatus coupled via a network.

FIG. 4 exemplifies one business application 113 but a plurality of business applications may run on the business host server 11a. The business application 113 may be a groupware/ email server program or a database management system, for example.

The storage systems 14a and 14b provide each business application with one or more copy pairs. As described above, the storage system 14a provides one business application with one or more primary volumes. The storage system 14b coupled to the storage system 14a via a remote path provides one or more secondary volumes associated with the primary volumes.

The pair management program 114 stores information on volumes provided to the business host server 11a. The pair management program 114 cooperates with the pair management programs on other business host servers to manage copy pairs. The pair management program 114 manages copy pairs in accordance with requests from the management server 12.

The business application 113 and the pair management program 114 are connected to the SAN 16 through the network interface 111 and access the storage systems 14a and 14b via the SAN 16. The business application 113 reads/writes application data from/to the primary volume.

The pair management program 114 performs creation of copy pairs, data replication, and control of the states of copy pairs. In this embodiment, the pair management program 114 can obtain a copy of a volume storing data used by the business host server 11a under the SAN environment. Using this function, the pair management program 114 obtains a backup of application data in this embodiment. The copy pair management function may be implemented in the management server 12.

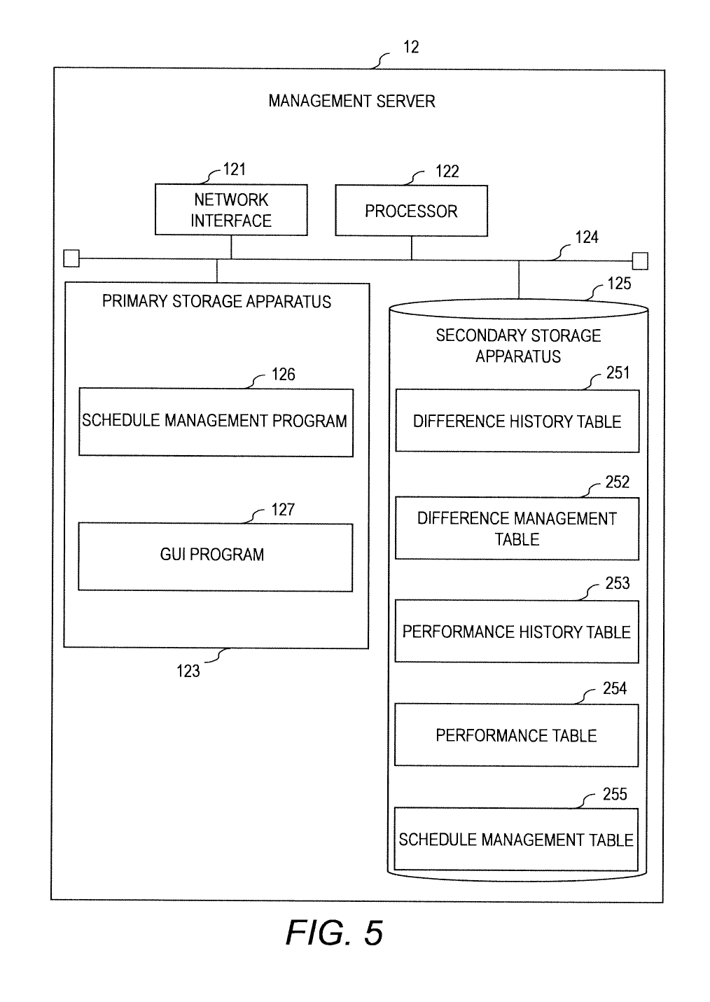

Next, with reference to FIG. 5, a configuration of the management server 12 will be described. The management server 12 is a computer for managing the storage systems 14a and 14b. As described above, the client 13 is coupled to the management server 12, so that it can refer to a variety of information on the storage systems 14a and 14b to manage the storage systems 14a and 14b based on the information.

As shown in FIG. 5, the management server 12 comprises a network interface 121, a processor 122, a primary storage apparatus 123, and a secondary storage apparatus 125. These are coupled with a bus 124 to be able to communicate with one another. The processor 122 executes programs stored in the primary storage apparatus 123 to provide predetermined functions of the management server 12.

The primary storage apparatus 123 stores programs to be executed by the processor 122 and data required for execution of the programs. The programs include a schedule management program 126 and a GUI (Graphical User Interface) program 127. The processor 122 may include a plurality of chips or a plurality of packages.

Typically, the programs are loaded from the secondary storage apparatus 125 to the primary storage apparatus 123. The secondary storage apparatus 125 is a storage apparatus including a non-volatile non-transitory storage medium for storing programs and data required to provide predetermined functions of the management server 12. The secondary storage apparatus 125 may be an external storage apparatus coupled via a network.

The schedule management program 126 manages the schedule of obtaining backup data of each business applications. The schedule management program 126 calculates the backup window and the backup start time for each business application under the constraints on the schedule intended by the user. The scheduling by the schedule management program 126 will be described later.

The GUI program 127 converts values calculated by the schedule management program 126 into readable information to provide the information to the client 13 operated by a user. The client 13 displays the display information obtained from the schedule management program 126 on its monitor 134.

As shown in FIG. 5, the secondary storage apparatus 125 stores a difference history table 251, a difference management table 252, a performance history table 253, a performance table 254, and a schedule management table 255. For convenience, FIG. 5 shows the tables in the secondary storage apparatus 125 but the data required for processing in the management server 12 are typically loaded from the secondary storage apparatus 125 to the primary storage apparatus 123 from the secondary storage apparatus 125. The information (data indicating the information) is stored in the storage area thereof in the primary storage apparatus 123 and the secondary storage apparatus 125.

The schedule management table 255 is a table for storing information on a backup schedule calculated by the schedule management program 126. The difference history table 251 is a table for storing information on differences between each copy pair for each application (data difference between the primary volume and the secondary volume) at the start time of data replication. The schedule management program 126 compensates for the discrepancy between the difference at the time of calculation of the schedule and the difference at the start time of data replication, based on the information in these tables.

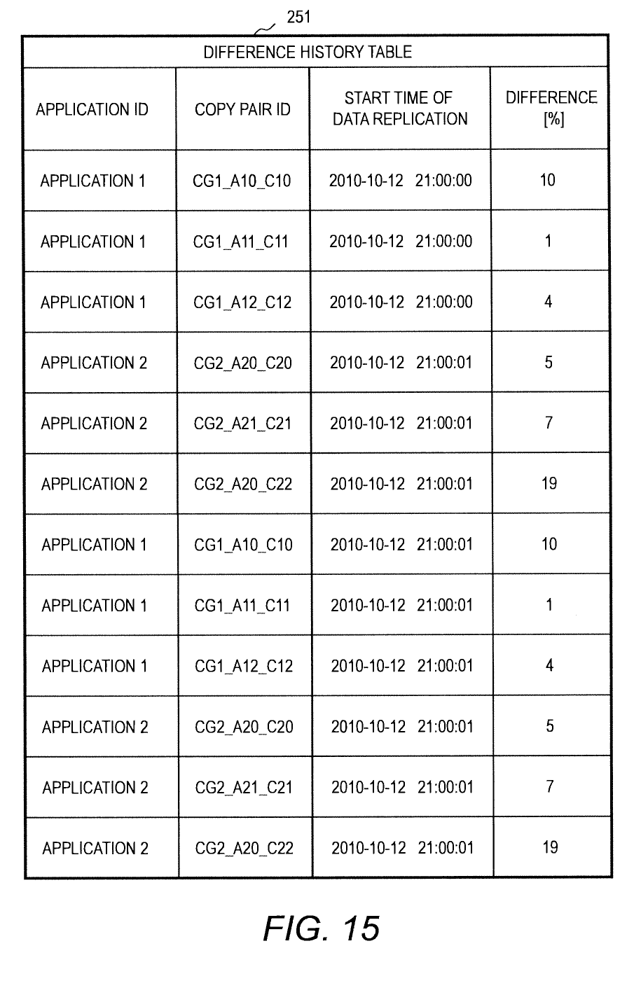

The difference management table 252 is a table for storing information indicating the current difference between each copy pair of each application. The performance history table 253 is a table for storing information on performance in data transfer between each copy pair in data replication based on the schedule management table 255. The performance table 254 is a table for storing information on current performance. The details of these tables will be described later with reference to FIG. 15 to FIG. 19.

In this configuration, the client 13 and the management server 12 configure a management system. The management system may be configured with a management server equipped with an input and output device or may include a plurality of servers each having a part or all of the functions of the management server 12. For example, the business host servers 11a and 11b are constituents of the business system, but may constitute a part of the management system as well.

As described above, the schedule management program 126 schedules a backup between copy pairs provided for a plurality of applications. Hereinafter, an example of backup scheduling in this embodiment will be described.

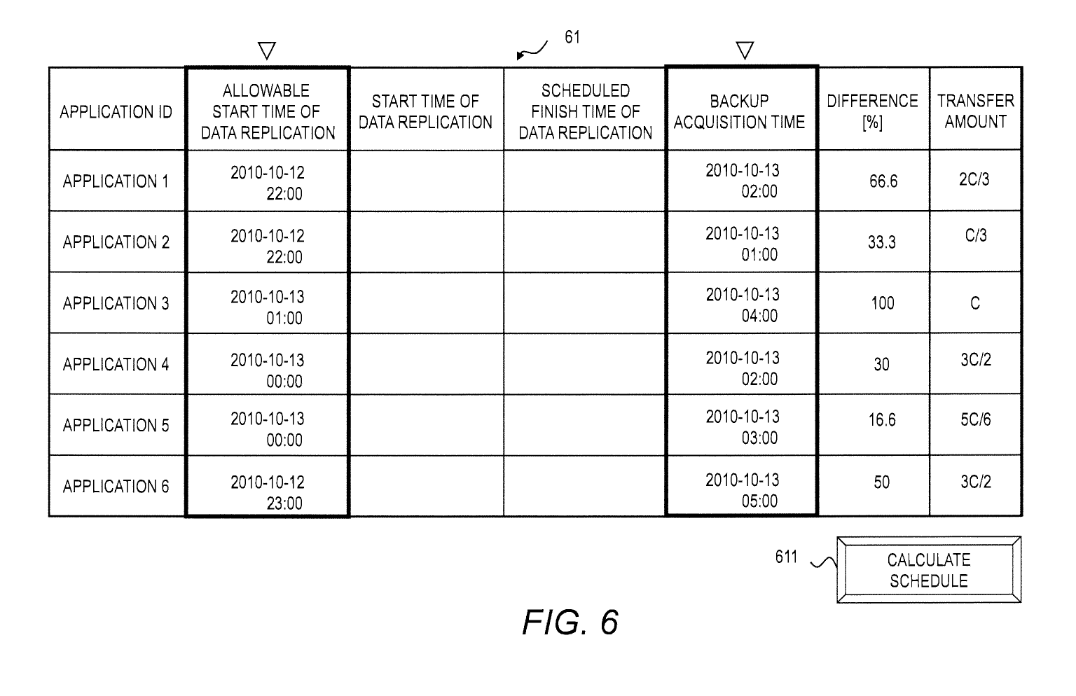

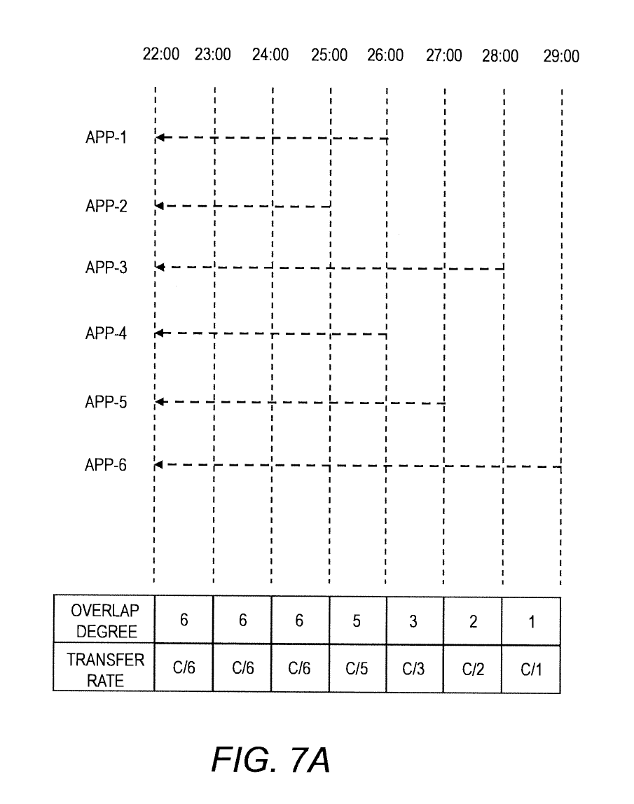

FIG. 6 shows an example of a screen image of a schedule table 61 in the backup scheduling. The schedule management program 126 gives the GUI program 127 information to create the schedule table 61 including values to be stored in the schedule table 61. The GUI program 127 creates an image data of the schedule table 61 from the obtained information and transmits it to the client 13.

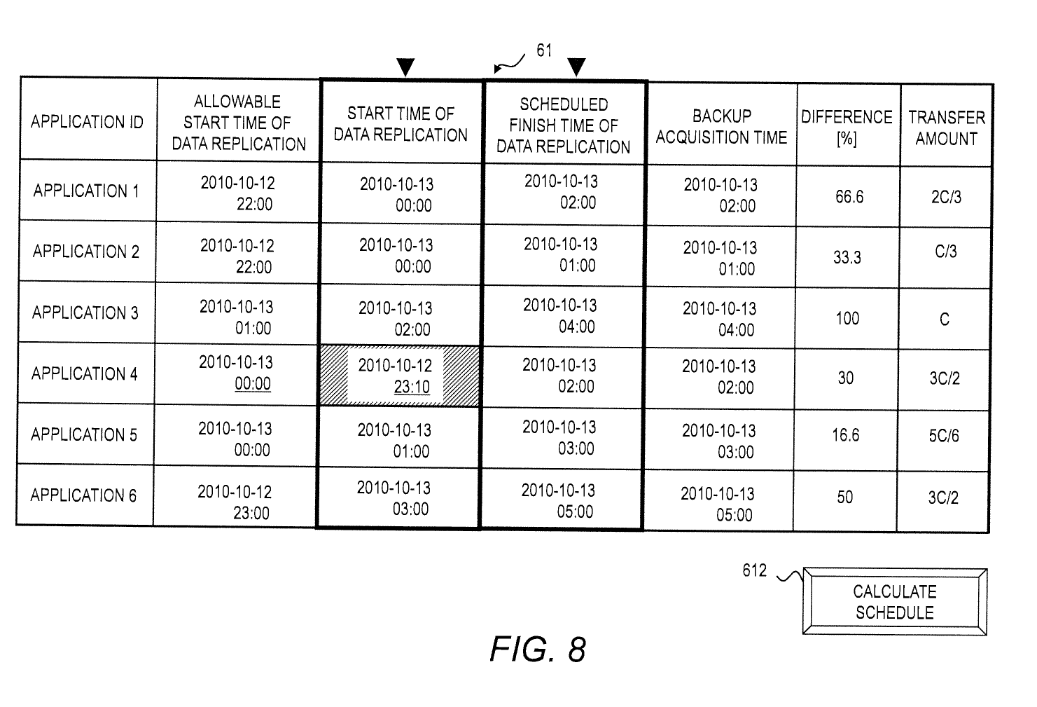

The browser program 135 in the client 13 displays the image on its monitor 134. The user inputs information for backup scheduling to the schedule table 61 in the image. The schedule table 61 indicates the result of scheduling calculation by the schedule management program 126 afterwards. The displayed image will be described later with reference to FIG. 8.

As shown in FIG. 6, the schedule table 61 includes columns of application ID, allowable start time of data replication, start time of data replication, scheduled finish time of data replication, backup acquisition time, difference, and transfer amount. The application IDs are identification information on applications running in the system. This example backs up the data of six applications. In this embodiment, data other than IDs, such as names may be used to identify targets. In the schedule table 61, time information is indicated in time and date. The date may be used or omitted depending on the design.

The allowable start time of data replication, the start time of data replication, the scheduled finish time of data replication, and the backup acquisition time have been explained with reference to FIG. 2. The difference [%] indicates the total amount of data differing between all of the (one or more) copy pairs provided by the storage systems 14a and 14b for each application.

The transfer amount is the amount of data to be transferred so that each copy pair are synchronized with each other for all of the (one or more) copy pairs in the storage systems 14a and 14b allocated to applications. The value obtained by multiplying the total volume capacity of the primary volumes by the associated difference [%] is the transfer amount for the application. For example, the volume capacity provided for the application 1 is C and the volume capacity provided for the application 4 is 5C.

As to the schedule table 61 of FIG. 6, the schedule management program 126 displays a table preliminarily storing data in the fields of the application ID, the difference, and the transfer amount. The values of the application IDs to be the targets of the backup scheduling are preliminarily registered in the schedule management program 126.

The schedule management program 126 can obtain information on data difference for each application from the pair management programs 114 in the business host servers 11a and 11b. The schedule management program 126 can obtain other information about application data from the pair management program 114, which will be described later.

The user inputs numeric values to the fields in the columns of the start time of data replication and the backup acquisition time in the schedule table 61 (indicated by white triangles in FIG. 6) using the input apparatus 131. FIG. 6 shows the schedule table 61 with these values inputted. In this example, the buffering period is not set by the user. The user may determine the backup acquisition time while considering the difference between the scheduled finish time of data replication and the actual finish time. It is preferable that the buffering period can be specified by the user.

Typically, the user prepares a schedule several hours or several days before the actual backup job. Accordingly, the schedule management program 126 cannot know the precise amount of data (transfer amount) for each application to be actually transferred in the backup job at the backup scheduling

For this reason, the schedule management program 126 uses a predicted value of data transfer amount in each application data (the data for each application) in the backup scheduling. The schedule management program 126 may use the last data transfer amount or a statistic value of the past data transfer amount (for example, the average value of the past several times of transfers). The schedule management program 126 may monitor the difference [%] in the data replication target (primary volume) (corresponding to the update data amount and the data transfer amount) to predict the data transfer amount in the backup job using the current value of the difference.

The schedule management program 126 determines the backup schedule considering the system performance of the storage system (including the two storage systems 14a and 14b and the network (remote path) connecting them in the configuration of FIG. 1). Specifically, the schedule management program 126 uses the data transfer rate of the remote path between the storage systems 14a and 14b in calculating each backup schedule. It should be noted, however, the bandwidth available in replicating application data (the data transfer rate of the remote path) is not constant but changes momentarily.

Hence, the schedule management program 126 uses a predicted value for the data transfer rate in calculating the schedule. The example described below uses an invariable as the data transfer rate. In a preferable configuration, the schedule management program 126 calculates the schedule using the predicted value of data transfer rate changing with time. This will be described later.

The schedule management program 126 determines the scheduled finish time of data replication for each application and further, determines the start time of data replication, using the values in the schedule table 61 shown in FIG. 6. The schedule management program 126 determines the backup schedule so that the scheduled finish time of data replication for each application will not be later than the preset backup acquisition time.

In this way, in the scheduling of this example, the preset backup acquisition time is the finish time of the backup job specified by the user and the schedule management program 126 determines the start time of each data replication so that the scheduled finish time of the data replication will be the same as or earlier than the backup acquisition time. To shorten the period in the state of Pair, it is preferable that the scheduled finish time of data replication be the same as the backup acquisition time.

As described above, since the actual data transfer amount and data transfer rate are not determined at scheduling, it cannot eliminate that the scheduled finish time of data replication differs from the actual finish time of data replication. Accordingly, the user typically sets the specified finish time of data replication (in this example, the backup acquisition time specified by the user) prior to the absolute finish time of data replication (in this example, the actual backup acquisition time).

The schedule management program 126 determines the scheduled finish time of data replication and calculates the start time of data replication with reference to the determined finish time. In the example described below, the schedule management program 126 calculates a schedule for each application using the backup acquisition time as the initial value of the scheduled finish time of data replication.

If the backup schedule in which scheduled finish times of data replications are the same as the respective backup acquisition times has a problem (predetermined scheduling requirements are not satisfied), the schedule management program 126 recalculates the schedule in accordance with the user's instruction or predetermined settings to change the scheduled finish times of data replications for one or more applications. As described above, in this configuration, the scheduled finish times of data replications will not be later than the backup acquisition times in the recalculated schedule.

A specific problem in the backup scheduling is that the start time of data replication (RS) in some application is earlier than the allowable start time of data replication (SF). As described referring to FIG. 2, the start time of data replication (RS) must be the same as or later than the allowable start time of data replication (SF). The schedule management program 126 updates the schedule (conducts rescheduling) by changing the data replication periods for a part of the applications (one or both of the start times and the scheduled finish times) so as to satisfy this requirement.

When the user selects a calculate schedule button 611 in the displayed image in FIG. 6 through the browser program 135, the schedule management program 126 executes calculation for data replication scheduling in accordance with the preset values in FIG. 6. Hereinafter, the method of calculating the schedule will be described.

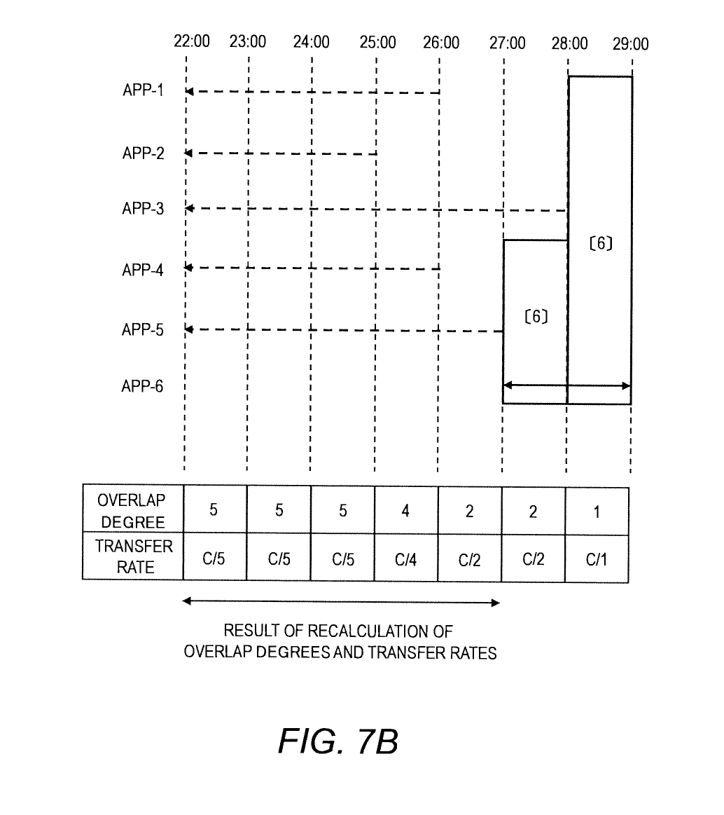

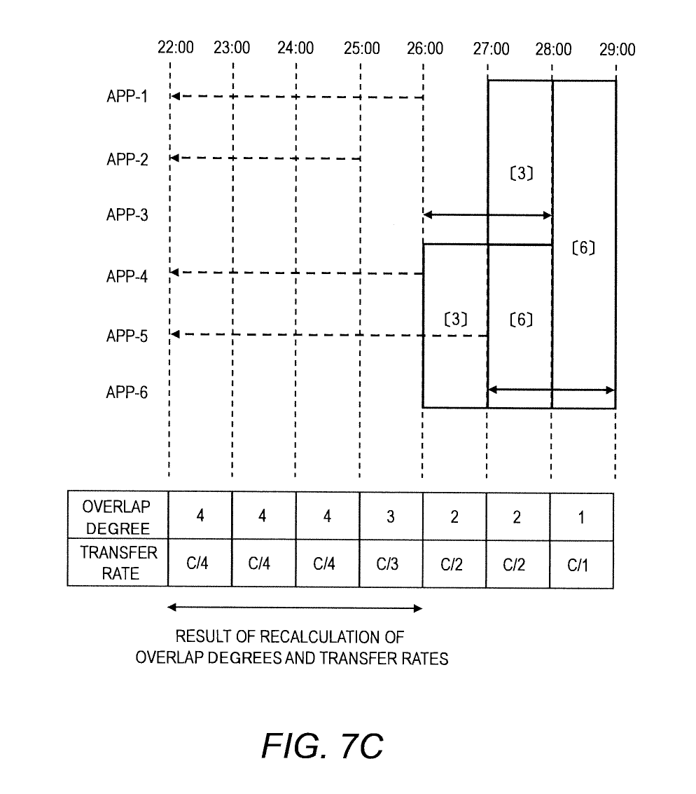

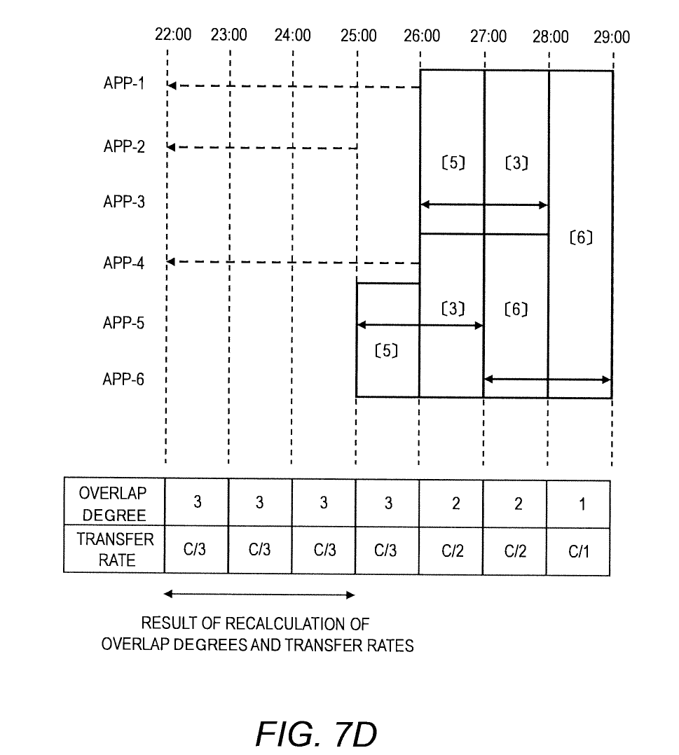

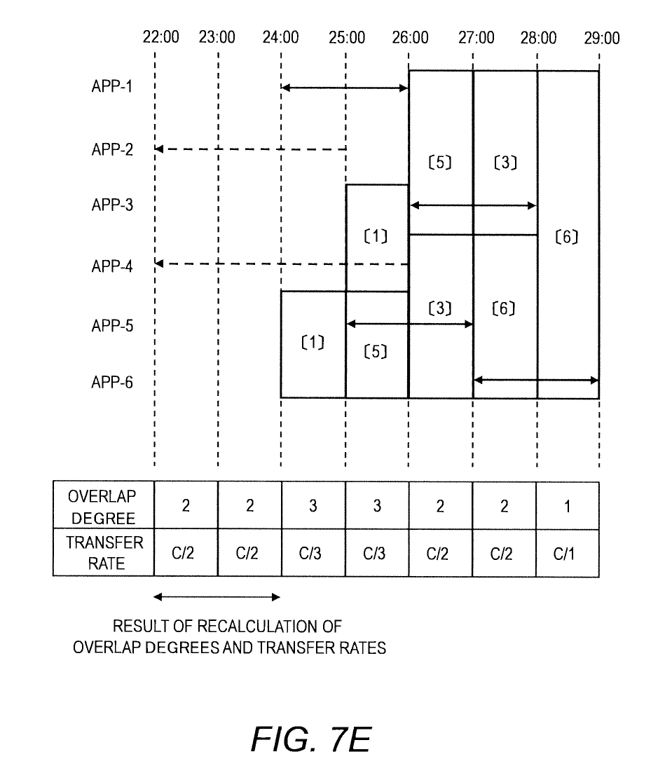

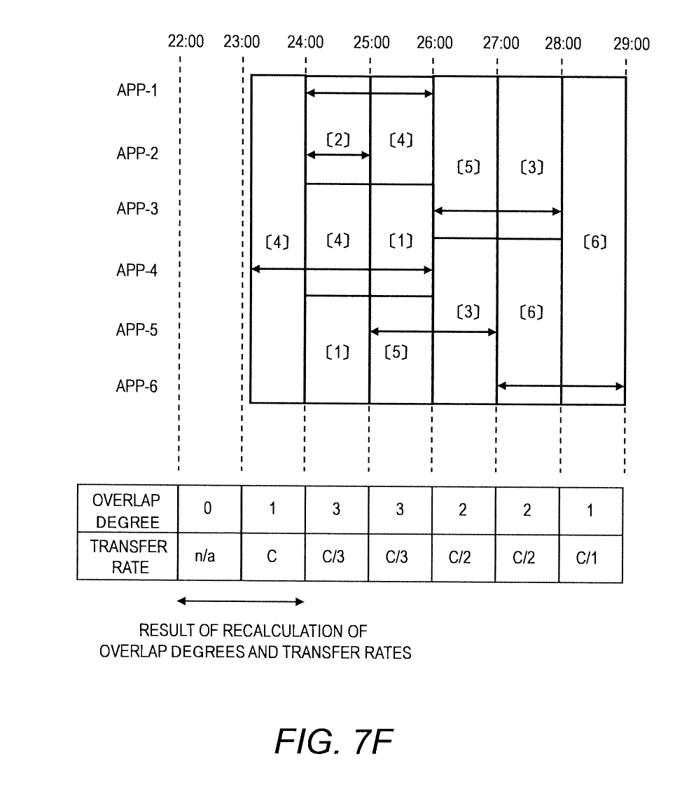

FIG. 7A is a chart of a backup schedule in accordance with the user-specified information indicated in FIG. 6. The arrows represent the initial candidates of data replication periods for the applications (APP-1 to APP-6). They are provisional data replication periods. The start point of each arrow corresponds to the backup acquisition time for each application.

In this example, it is assumed that the data replication period for each application starts at infinite time before the start time of the backup job. In other words, regarding each application, the whole time period before the backup acquisition time is the initial candidate for data replication period. The arrow in each application indicates that the time slots before the backup acquisition time for the application can be the initial candidate for data replication period. Although the ends of the arrows are aligned at 22:00 in FIG. 7A, the arrows continue to the infinite in scheduling calculation.

FIG. 7A further shows an overlap degree and a data transfer rate among (the applications subjected to) the data replications in each time slot of one hour. The data transfer rate C [GByte/hour] in the remote path indicates the capacity of the data transfer amount in an hour on the remote path. In this example, the data transfer rate C in the remote path is an invariable which does not change with time.

In each time slot, the data transfer rate allocated to an application is to be the value obtained by dividing the performance C of the remote path by the overlap degree of the applications (data replications) in the tile slot. Namely, the fraction of performance distribution of the data transfer rate in a certain time slot is 1/(overlap degree). The value (initial value) of the overlap degree in each time slot shown in FIG. 7A is a provisional value. The scheduling calculation selects applications one by one to determine their data replication periods (the start times of data replications), and updates the values of the overlap degrees with the change in the data replication periods from the initial candidates.

In this example, the data transfer rate C in the remote path is assumed to be an invariable; however, a preferable configuration obtains the statistics of C(t) in each time slot and calculates C(t) in each time slot to use it in the scheduling calculation. This will be described later.

In the example described below, the period for replicating data is divided into time slots of one hour and the overlap degree of applications (data replication periods) is determined in each time slot. The time slot may have an appropriate length, for example, one minute or ten minutes, in accordance with the design. Typically, all of the time slots have the same length, but may have different lengths.

The schedule management program 126 first schedules data replications so that the scheduled finish time of data replication in each application will be the same as the backup acquisition time specified by the user. This operation reduces the time period from the actual finish time of data replication to the actual backup acquisition time (the period in which copy pairs are in Pair state) and reduces data transfer to keep the Pair state. If any start time of data replication is earlier than the allowable time of data replication in the result of the calculation, the schedule management program 126 recalculates the schedule by the user's instruction or automatically.

The schedule management program 126 selects applications in order from the one for which the backup acquisition time is the latest to sequentially calculate the start times of data replication for the applications. As shown in FIG. 7A, at the start of calculation, the application for which the backup acquisition time is the latest is APP-6. FIG. 7B shows the result of calculation of the data replication period for the APP-6.

In FIG. 7B, the rectangles in the chart represent data to be transferred and the figures in the rectangles indicates the relevant application. A side X of a rectangle represents time length and a side Y represents allocated transfer rate. Namely, the area of a rectangle represents the amount of data to be transferred.

In the chart of FIG. 7B, the data of APP-6 in the amount of data C is transferred from 28:00 to 29:00 and the data of APP-6 in the amount of data C/2 is transferred from 27:00 to 28:00. All data to be transferred in APP-6 are transferred from 27:00 to 29:00 and the solid line with bi-directional arrows represents the data replication period for APP-6.

As shown in FIG. 6, the backup acquisition time for APP-6 is 29:00. From the amount of data to be transferred in APP-6 and the transfer rates allocated to the time slots before 29:00 (C and C/2), the schedule management program 126 can obtain the start time of data replication for APP-6 at 27:00.

Since the times for the data replication (the start time and the scheduled finish time) for APP-6 are determined, the schedule management program 126 recalculates the overlap degrees and the transfer rates to be allocated to the applications from 22:00 to 27:00 and updates the values, as shown in FIG. 7B.

Next, the schedule management program 126 calculates the start time of data replication for APP-3, for which the backup acquisition time is the second from the latest (for which the backup acquisition time is the latest among the undetermined applications). FIG. 7C shows the result of the calculation. The backup acquisition time for APP-3 is 28:00 and as shown in FIG. 7B, the allocated transfer rates in the time slots of 26:00 to 27:00 and 27:00 to 28:00 are C/2.

The schedule management program 126 can obtain the start time of data replication for APP-3 at 26:00 from the backup acquisition time for APP-3, the amount of data to be transferred for APP-3 (C), and the allocated transfer rates in the time slots before 28:00. Since the times for the data replication (the start time and the scheduled finish time) for APP-3 is determined, the schedule management program 126 recalculates the overlap degrees and the transfer rates from 22:00 to 26:00 and updates them, as shown in FIG. 7C.

Next, the schedule management program 126 calculates the data replication period for APP-5, for which the backup acquisition time is the third from the latest (for which the backup acquisition time is the latest among the undetermined applications). FIG. 7D shows the result of the calculation. The backup acquisition time for APP-5 is 27:00 and as shown in FIG. 7C, the allocated transfer rate in the time slot of 25:00 to 26:00 is C/3 and the one in the time slot of 26:00 to 27:00 is C/2.

The schedule management program 126 can obtain the start time of data replication for APP-5 at 25:00 from the backup acquisition time for APP-5, the amount of data to be transferred for APP-5 (5C/6), and the allocated transfer rates in the time slots before 27:00. Since the data replication times (the start time and the scheduled finish time) for APP-5 is determined, the schedule management program 126 recalculates the overlap degrees and the transfer rates from 22:00 to 25:00 and updates them, as shown in FIG. 7D.

Next, the schedule management program 126 calculates the data replication period for APP-1, for which the backup acquisition time is the fourth from the latest (for which the backup acquisition time is the latest among the undetermined applications). FIG. 7E shows the result of the calculation. The backup acquisition time for APP-1 is 26:00 and as shown in FIG. 7D, the allocated transfer rates in the time slots of 24:00 to 25:00 and 25:00 to 26:00 are C/3.

The schedule management program 126 can obtain the start time of data replication for APP-1 at 24:00 from the backup acquisition time for APP-1, the amount of data to be transferred by APP-1 (2C/3), and the allocated transfer rates in the time slots before 26:00. Since the data replication times (the start time and the scheduled finish time) for APP-1 is determined, the schedule management program 126 recalculates the overlap degrees and the transfer rates from 22:00 to 24:00 and updates them, as shown in FIG. 7E.

In similar, the schedule management program 126 calculates for the remaining applications APP-2 and APP-4. FIG. 7F shows the result of the calculation. The data of APP-2 is transferred in the time slot of 24:00 to 25:00. The start time of data replication for APP-4 is 23:10 and the scheduled finish time of data replication is 25:00, which is the same as the backup acquisition time. The overlap degrees and the transfer rates in FIG. 7F is the definitive values after scheduling.

The above processing sequentially selects applications in order from the application for which scheduled finish time of data replication is the latest to determine the time period of data replication (the start time of data replication) for each application. Moreover, it recalculates and updates the provisional initial values for overlap degrees. In this way, the schedule management program 126 repeats the steps of selecting the application for which scheduled finish time of data replication is the latest among the uncalculated applications, calculating the start time of data replication, and updating the overlap degree and the data transfer rate to be allocated in each time slot prior to the start time of data replication.

Sequential calculation of start times of data replications one by one from the application for which the scheduled finish time of data replication is the latest achieves efficient and proper calculation of start times of data replications for all of the applications. The schedule management program 126 may select the applications in accordance with any other order depending on the design.

In the foregoing example, the schedule management program 126 assumes that the data replication period in each application is a period lasting to an infinite time before the scheduled finish time of data replication to determine a provisional data replication period (overlap degrees) (FIG. 7A). The schedule management program 126 may use a period different from the infinite period to determine provisional overlap degrees for the initial values of the overlap degrees (transfer rates to be allocated to each application). For example, the schedule management program 126 may define the period from a specific time to the finish time of data replication or a certain length of period from the finish time of data replication as the provisional data replication period.

FIG. 8 shows a displayed image of the schedule table 61 corresponding to the result of calculation in FIG. 7F. The schedule table 61 stores the start time of data replication and the scheduled finish time of data replication for each record (application) determined by the first scheduling calculation (FIG. 7A to FIG. 7F). In FIG. 8, the field of the start time of data replication for the application 4 is hatched.

As shown in FIG. 8, the allowable start time of data replication for the application 4 is 00:00 (24:00). However, the start time of data replication for the application 4 calculated by the foregoing scheduling calculation is 23:10. This start time of data replication is earlier than the allowable start time of data replication; it does not satisfy the predetermined scheduling requirements. The scheduling requirements in this example are that the start time of data replication be the same or later than the allowable start time of data replication and the scheduled finish time of data replication be the same as or earlier than the backup acquisition time.

In the initial scheduling calculation, the schedule management program 126 schedules each data replication period so that the scheduled finish time of data replication will be the same as the backup acquisition time. Accordingly, the scheduling requirement that might not be satisfied is the requirement for the start time of data replication.

The schedule management program 126 recalculates the schedule and checks whether the start times of data replications for all of the applications including the application 4 are the same as or later than the respective allowable start times of data replications. The schedule management program 126 conducts the scheduling recalculation under the condition where the scheduled finish times of data replications for all of the applications will not be later than the respective backup acquisition times.

The user selects the button 612 for scheduling recalculation displayed by the browser program 135 with the input apparatus 131. The schedule management program 126 starts recalculation in response to it. The schedule management program 126 may automatically recalculate the schedule without displaying the schedule table 61 of FIG. 8.

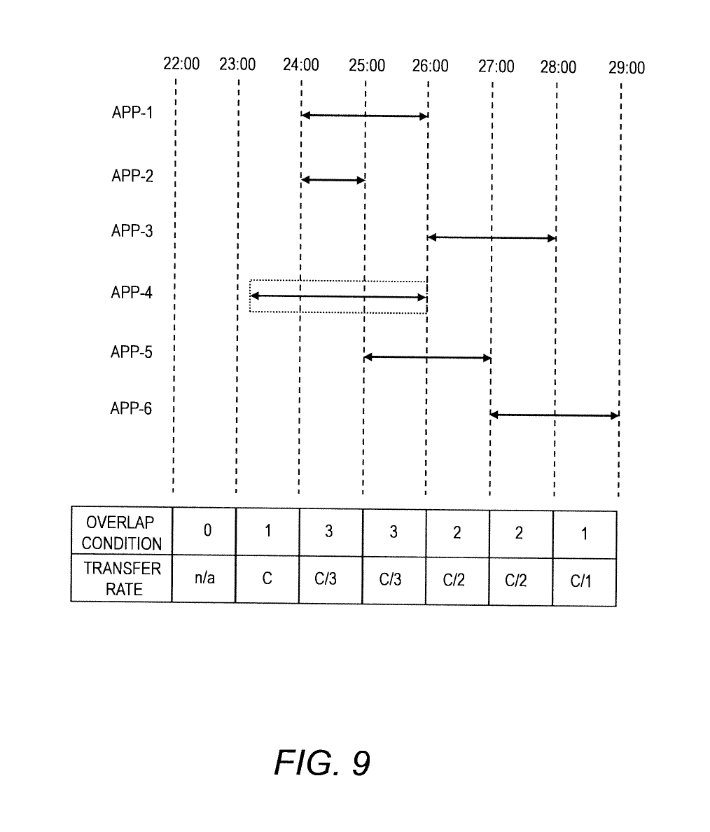

FIG. 9 shows a chart indicating the result of scheduling obtained by the above-described scheduling calculation and an overlap degree and an allocated transfer rate in each time slot, where the rectangles indicating data transfers are removed from FIG. 7. As shown in FIG. 9, the data replication period for APP-4 overlaps with the data replication periods for APP-1, APP-2, and APP-5.

Hereinafter, an application in need of changing the data replication period, specifically the start time of the data replication, is referred to as an application in need of change and the data replication period therefore is referred to as a data replication period in need of change. Moreover, an application for which the data replication period overlaps the data replication period for the application in need of change is referred to as an application concerned. The data replication period for an application concerned is referred to as a data replication period concerned.

As will be described later, not all of the data replication periods concerned can contribute to the change of the start time of a data replication period in need of change. In the data replication periods concerned, a data replication period concerned of which change can contribute to the adjustment of (delaying) the start time of the data replication period in need of change is referred to as a coordinatable data replication period. The application for which data replication period is a coordinatable data replication period is referred to as a coordinatable application.

To change (delay) the data replication period (start time of the data replication) for APP-4, it is necessary to change a data replication period overlapping therewith so that the overlapping period will be shorter. Accordingly, the schedule management program 126 selects an application from the coordinatable applications to shift the start time of data replication for the selected application to an earlier time. This operation raises the data transfer rate allocated to the application in need of change to delay the start time of data replication.

It is preferable that the number of applications to change their data replication period, in other words, the number of applications for which scheduled finish time of data replication are not the same as the backup acquisition time be the minimum.

In a preferred configuration, the schedule management program 126 selects coordinatable applications one by one to conduct scheduling recalculation. When the start times of data replications for all of the applications including the application in need of change becomes the same as or later than the allowable start times of data replications, the schedule management program 126 terminates the scheduling recalculation without changing the remaining coordinatable data replication periods.

Depending on the design, the schedule management program 126 may determine whether the start time of data replication for the application in need of change satisfies the scheduling requirements, namely, whether the start time of data replication is either the same as or later than the allowable start time of data replication, after recalculating the scheduling that accompanies changes in the data replication periods for some or all of the coordinatable applications with regard to the start time of data replication for the application in need of change.

To suppress the number of applications for which the data replication periods are changed, it is necessary to select the data replication period for an application that contributes to the change to delay the target start time of data replication (in this example, the start time of data replication for APP-4). Moreover, it is preferable to select the data replication period whose contribution is the greatest or most likely to be the greatest.

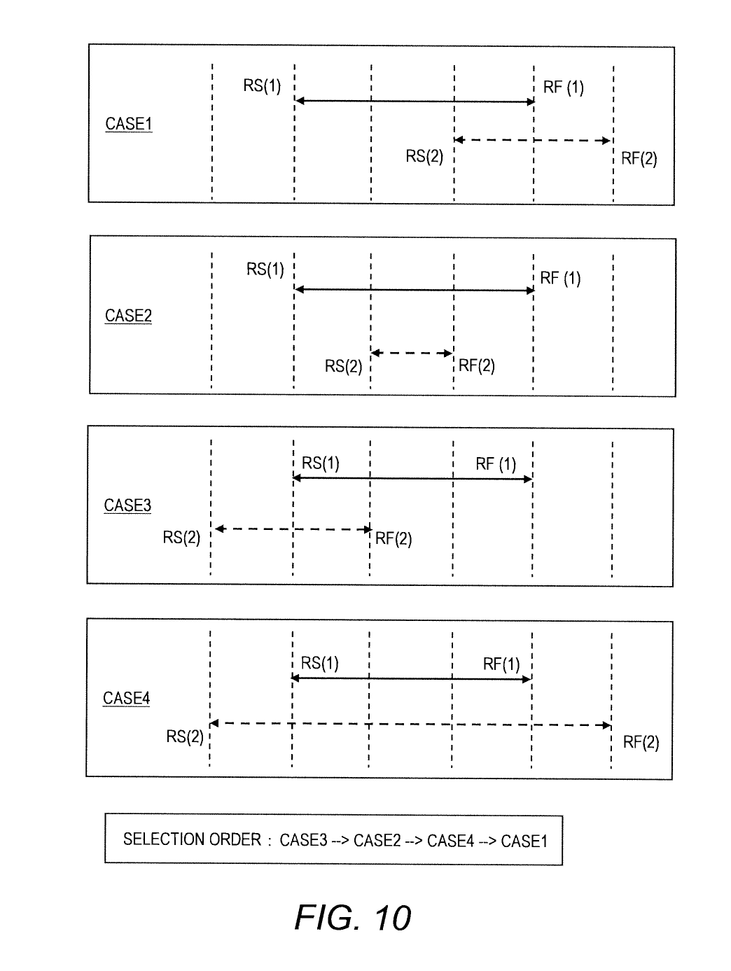

The schedule management program 126 selects applications to change the data replication periods by the method described hereinafter. FIG. 10 shows different overlap patterns between two data replication periods. In FIG. 10, the solid lines with arrows are the data replication period in need of change for which the start time of the data replication needs to change (in this example, the data replication period for APP-4) and the dashed lines are the data replication periods for applications concerned. In the following description, time A<time B means that the time B is later than the time A; period A<period B means that the period B is longer than the period A.

As shown in FIG. 10, there exist four overlap patterns between the data replication period in need of change and the data replication periods concerned (CASE 1 to CASE 4). In FIG. 10 and the following descriptions, SF(1), RS(1), and RF(1) represent the allowable start time of data replication, the start time of data replication, and the scheduled finish time of data replication, respectively, of the application in need of change. SF(2), RS(2), and RF(2) represent the allowable start time of data replication, the start time of data replication, and the scheduled finish time of data replication, respectively, of an application concerned.

In CASE 1 in FIG. 10, the relationship of RS(1)≦RS(2)<RF(1)<RF(2) exists. In CASE 1, if the allowable start time of data replication for the application concerned SF(2) is the same as or later than the start time of data replication for the application in need of change RS(1) (SF(2)≧RS(1), CASE 1-1), a shift of the data replication period concerned cannot contribute to the change of the start time of data replication for the application in need of change RS(1).

If SF(2)<RS(1) and RS(1)−SF(2)≧RF(1)−RS(2) exists in CASE 1 (CASE 1-2-1), shifting the data replication period concerned can contribute to delaying RS(1). However, if the start time of data replication for the application concerned RS(2) is made to be the same as its allowable start time of data replication SF(2) and the amount of data to be transferred for the application concerned cannot be transferred within the data replication period, the data replication period for the application concerned cannot be shifted.

If SF(2)<RS(1) and RS(1)−SF(2)<RF(1)−RS(2) exists in CASE 1 (CASE 1-2-2) and the data replication period concerned is shifted so that the start time of data replication will be the same as the allowable start time of data replication (SF(2)=RS(2)), the shift cannot contribute to delaying the start time of data replication for the application in need of change RS(1).

The above-described initial scheduling calculation makes the scheduled finish times of data replications RF for all of the applications the same as the backup acquisition times B (intended finish times of data replications). The schedule management program 126, in recalculating the schedule, does not make the scheduled finish time of data replication for the application concerned RF(2) later than the time calculated in the initial scheduling. For this reason, conditions to contribute to delaying RS(1) are severer compared to the following CASE 2, CASE 3, or CASE 4.

Next, CASE 2 will be discussed. In CASE 2, the relation of RS(1)≦RS(2)<RF(2)≦RF(1) exists. If RS(1)−SF(2)≦0 exists in CASE 2 (CASE 2-1), the data replication period is not allowed to be shifted. This is because, if it is shifted, the start time of data replication for the application concerned RS(2) will be earlier than its allowable start time of data replication SF(2).

If RS(1)−SF(2)>0 exists in CASE 2 (CASE 2-2), the data replication period concerned can be shifted. The reason why CASE 2 does not need conditioning like in CASE 1-1 or CASE 1-2 is that shifting RS(2) to the time earlier than RS(1), even a little, can basically contribute to delaying RS(1).

However, if the start time of data replication for the application concerned RS(2) is made to be the same as its allowable start time of data replication SF(2) and the amount of data to be transferred for the application concerned cannot be transferred, the data replication period for the application concerned cannot be shifted.

Next, CASE 3 will be discussed. In CASE 3, the relation of RS(2)<RS(1)<RF(2)≦RF(1) exists. If SF(2)<RS(2) exists in CASE 3, shifting the data replication period concerned can contribute to delaying the start time of data replication for the application in need of change RS(1).

However, like in the other cases, if the start time of data replication for the application concerned RS(2) is made to be the same as its allowable start time of data replication SF(2) but data amount to be transferred for the application concerned cannot be transferred, the data replication period for the application concerned cannot be shifted.

Next, CASE 4 will be discussed. In CASE 4, the relation of SF(2)<RS(2)<RS(1)<RF(1)<RF(2) exists. If RS(2)−SF(2)>RF(2)−RF(1) exists in CASE 4 (CASE 4-1), shifting the start time of data replication for the application concerned RS(2) to an earlier time can contribute to delaying the start time of data replication for the application in need of change RS(1).

However, if the start time of data replication for the application concerned RS(2) is made to be the same as its allowable start time of data replication SF(2) and the amount of data to be transferred for the application concerned cannot be transferred, the data replication period for the application concerned cannot be shifted.

If RS(2)−SF(2)≦RF(2)−RF(1) exists in CASE 4 (CASE 4-2), shifting the related data replication cannot contribute to delaying the start time of data replication for the application in need of change RS(1).

Through the above discussion, only a coordinatable application satisfying specified conditions among the applications concerned whose data replication periods overlap with the data replication period for the application in need of change can contribute to shifting the start time of data replication for the application in need of change to a later time, by changing its data replication period.

Through the above-described description, application whose data replication period meets any one of the CASE 1-2-1, CASE 2-2, CASE 3-1, and CASE 4-1 has a possibility to contribute to delaying the start time of data replication for the application in need of change. As described above, the coordinatable application is the application concerned that meets any one of the foregoing cases and is able to transfer the amount of data to be transferred if the start time of data replication RS is made to be the same as the allowable start time of data replication SF.

To delay the start time of data replication in a data replication period in need of change as much as possible, it is important to shift the coordinatable data replication period which most reduces the overlap period between the two data replication periods when it is shifted. From FIG. 10 and the above description, shifting the data replication period concerned in CASE 3 (CASE 3-1) is most likely to be the most effective on shifting the start time of data replication in need of change. CASE 2 (CASE 2-2) is the next, CASE 4 (CASE 4-1) is the third, and CASE 1 (CASE 1-2-1) is the last.

Hence, the schedule management program 126 selects coordinatable data replication periods in the above order, namely, in the order of CASE 3, CASE 2, CASE 4, and CASE 1 to recalculate the schedule. The schedule management program 126 has information for defining the coordinatable application and in addition, registered information defining the above-described overlap patterns of data replication periods and priority levels assigned to the overlap patterns.

In a scheduling recalculation, the schedule management program 126 determines whether each application concerned is a coordinatable application or not, and further determines the overlap pattern and the priority level of each coordinatable application with reference to the registration information. It selects the application with the highest priority as the target of scheduling recalculation. The sequence of the determination of priority level and the determination of coordinatable application may be opposite.

The schedule management program 126 may conduct a trial scheduling recalculation on all of the coordinatable data replication periods and selects the coordinatable data replication period which contributes most, meaning the start time of data replication for the application in need of change can be delayed most.

The scheduling recalculation ends if the change of the selected coordinatable data replication period can make the start time of data replication for the application in need of change the same as or later than the allowable start time of data replication.

If only the first selected data replication period cannot achieve coordination satisfying the above-described scheduling requirements, the coordinatable data replication period showing the second most contribution in the above-described trial calculation is changed. The schedule management program 126 sequentially adds data replication periods to be changed until all the start times of data replications satisfy the requirements to end the scheduling recalculation. The schedule management program 126 terminates the scheduling recalculation when scheduling recalculations on all of the coordinatable applications have been done, even if the scheduling requirements are not satisfied.

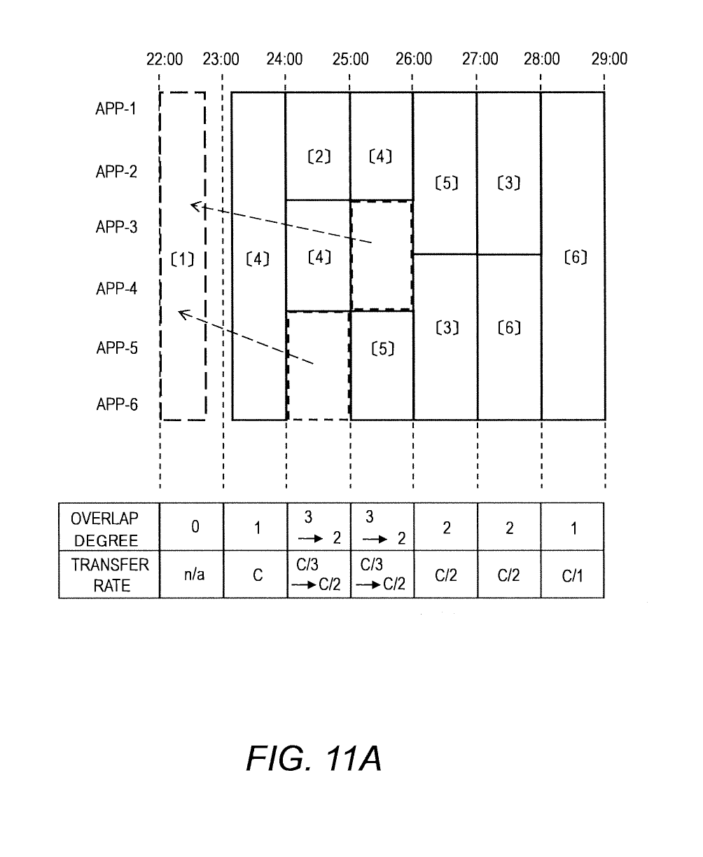

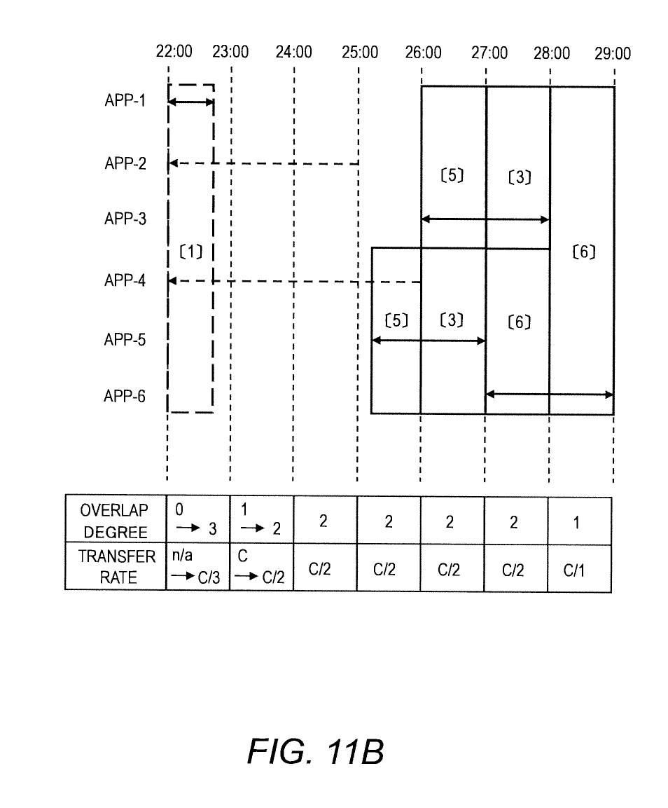

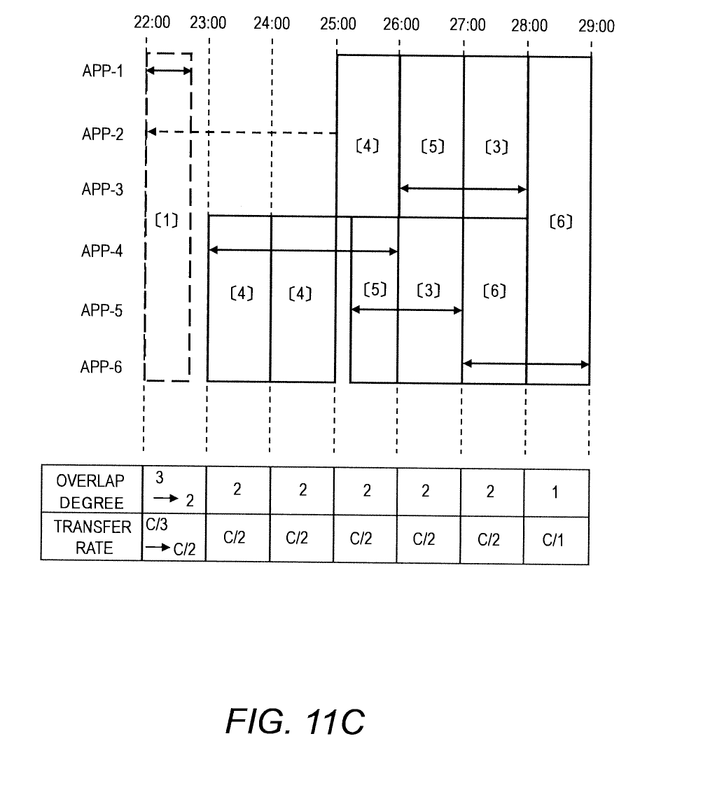

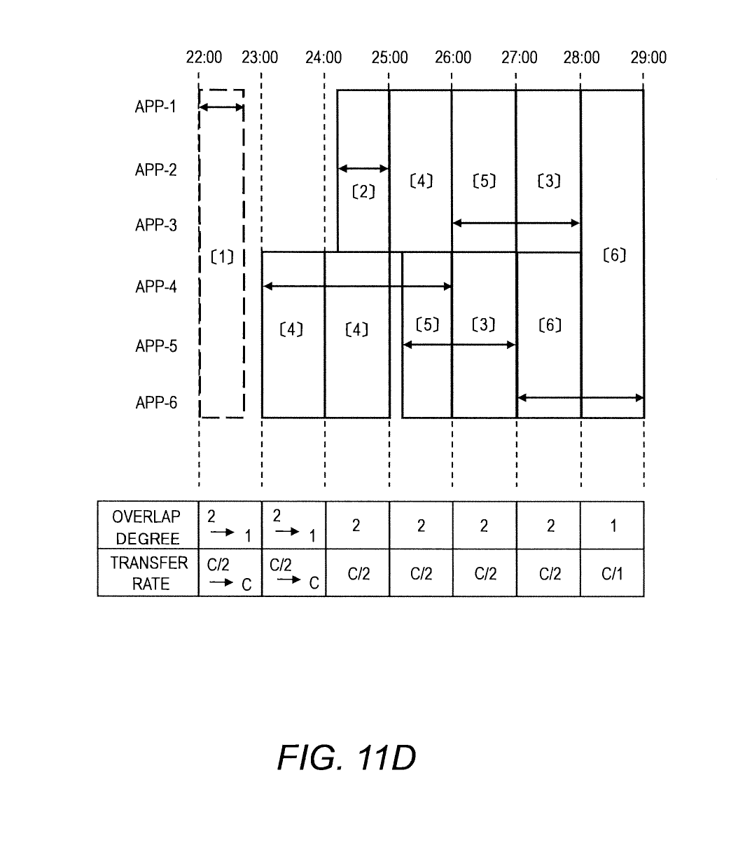

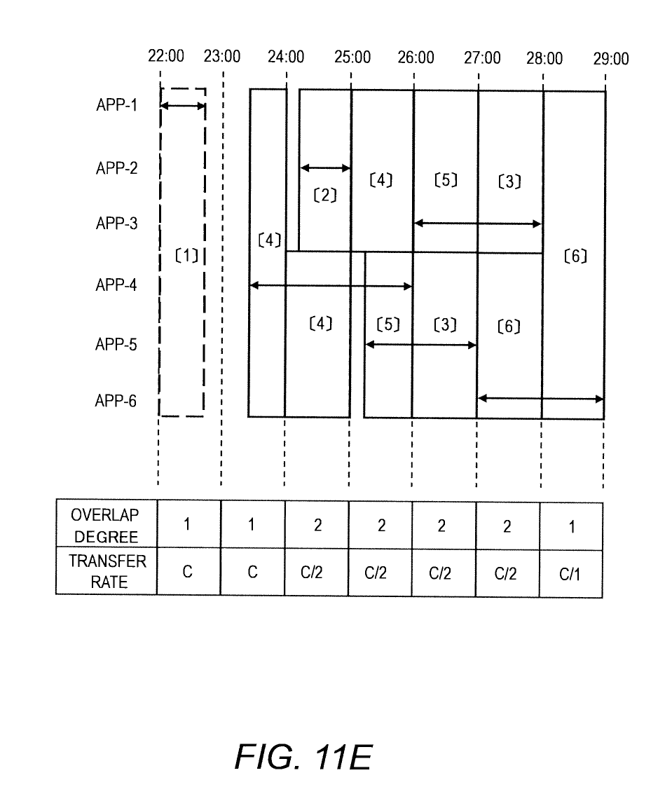

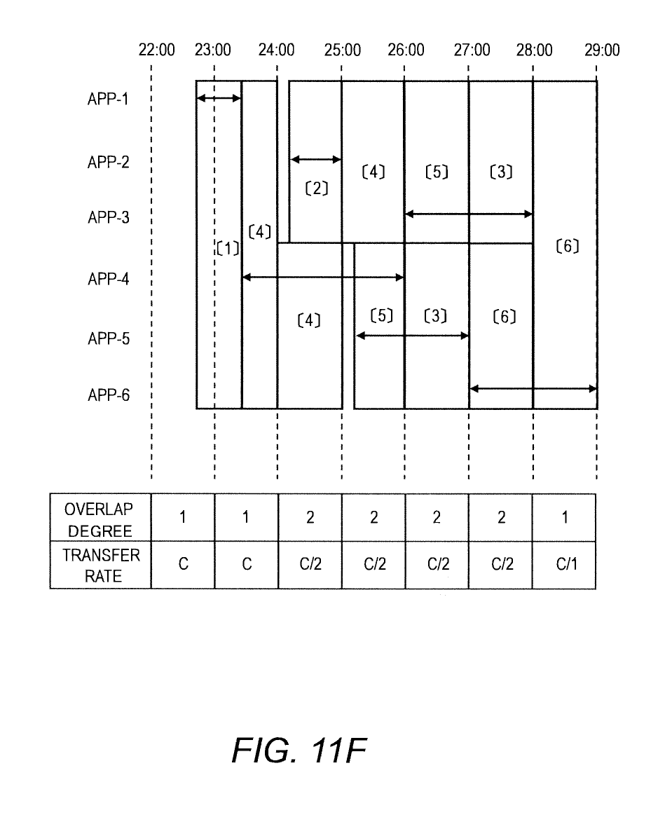

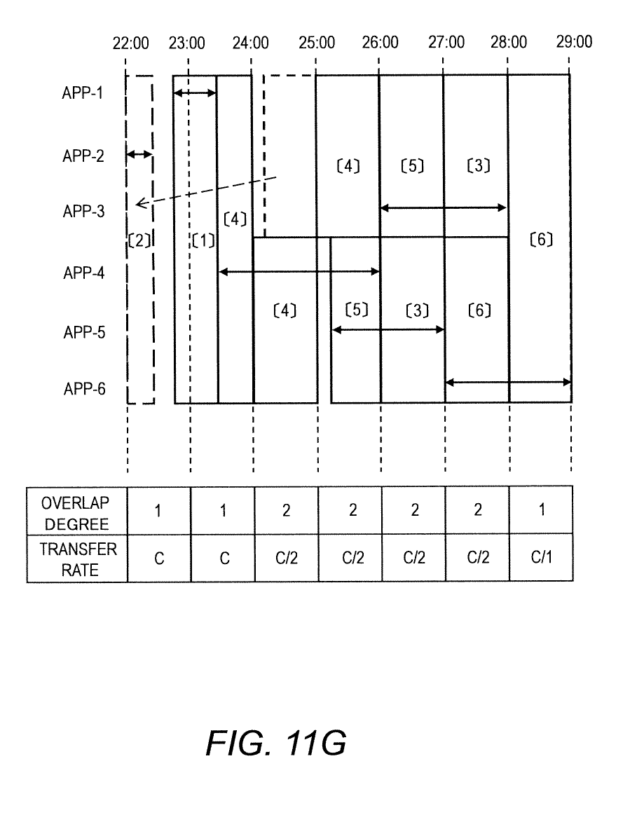

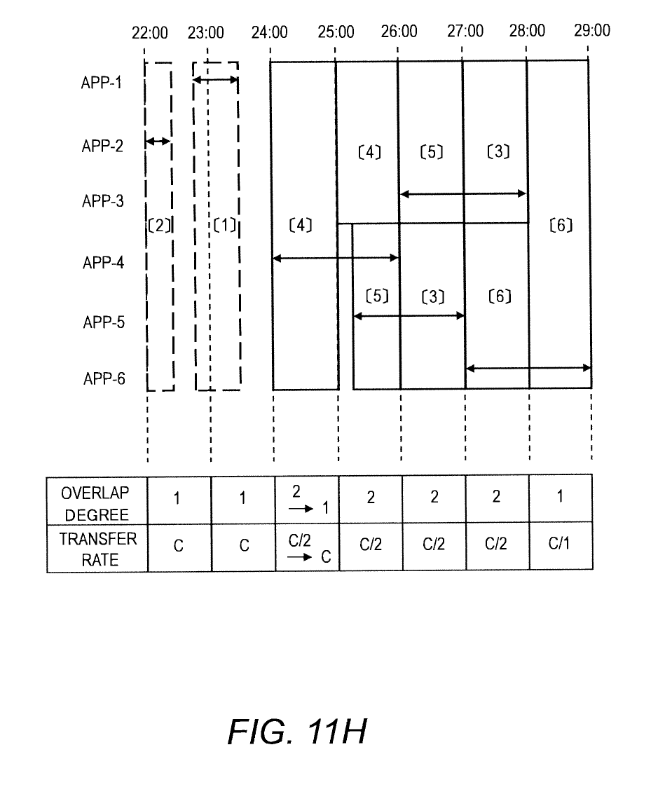

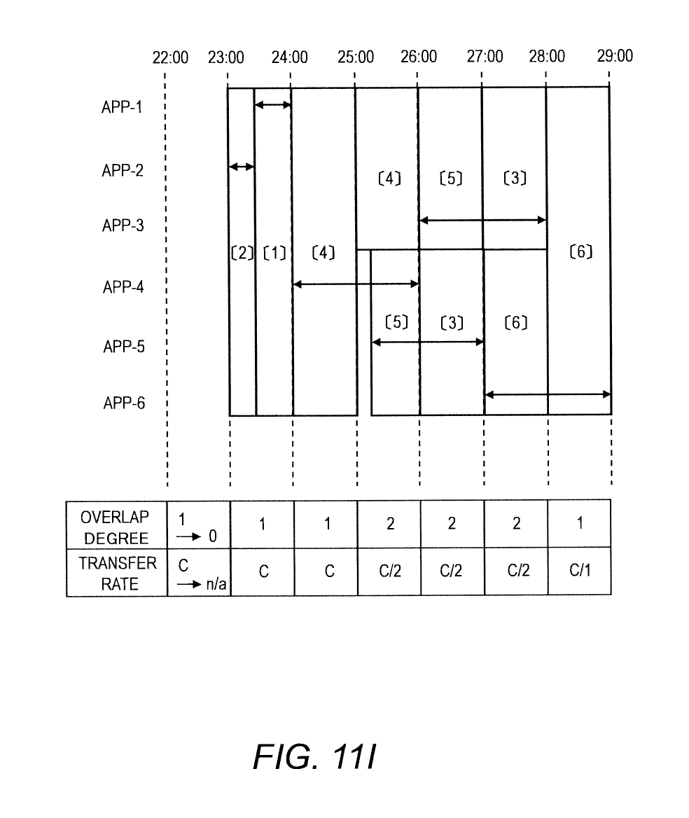

Hereinafter, an example of scheduling recalculation in accordance with the above-described order of application depending on the overlap pattern of data replication periods will be described referring to FIG. 11A to FIG. 11I. As shown in FIG. 9, the applications concerned with the application in need of change APP-4 are APP-1, APP-2, and APP-5. Of them, APP-5 applies to CASE 1-1. APP-1 and APP-2 apply to CASE 2-2. APP-1 and APP-2 are applications which can transfer the amount of data to be transferred when the start times of data replications RS are made to be the same as the allowable start times of data replications SF.

Accordingly, APP-1 and APP-2 are coordinatable applications and the overlap patterns of data replication periods are the same. For this reason, the schedule management program 126 may select either of the applications first for scheduling recalculation. In this example, the schedule management program 126 selects APP-1 with the smaller number as the first target to change the data replication period.

First, the schedule management program 126 shifts (advances) the start time of data replication RS for APP-1 to the allowable start time of data replication SF. Since the allowable start time of data replication SF for APP-1 is 22:00, it advances the start time of data replication RS for APP-1 by two hours. This is a provisional setting to the data replication period for APP-1.

FIG. 11A shows the result of shifting the data replication period for APP-1 from the result of the initial scheduling calculation (refer to FIG. 7F). Since the data transfer amount for APP-1 is 2C/3 and the overlap degree from 22:00 to 23:00 is 1 (the transferred data is only the data for APP-1), the scheduled finish time of data replication for APP-1 is 22:40. The schedule for APP-1 in FIG. 11A is a provisional schedule.

FIG. 11A further shows changes in overlap degree and allocated transfer rate in each time slot caused by the shift of data replication period for APP-1. The data replication period for APP-1 is shifted from the time slots of 25:00 to 26:00 and 24:00 to 25:00; the overlap degrees in the time slots are changed from 3 to 2 and the data transfer rate allocated to an application is changed from C/3 to C/2.

The schedule management program 126 initializes the schedule in the latest time slot where the shift of the data replication period for APP-1 causes changes in overlap degree and the time slots earlier than that. FIG. 11B shows the result of recalculation of the schedule of data replication period (reallocation of data replication period) for APP-5 by the schedule management program 126 after the initialization.

In FIG. 11B, the data replications for APP-2 and APP-4 have not been scheduled yet. The overlap degree from 25:00 to 26:00 is 2 and the remaining amount of data to be transferred for APP-5 is C/3. Accordingly, the schedule management program 126 determines the start time of data replication for APP-5 at 25:20. As a result of the initialization of the schedules for APP-2 and APP-4, the schedule management program 126 updates the overlap degrees and transfer rates in the time slots of 22:00 to 23:00 and 23:00 to 24:00.

Next, the schedule management program 126 recalculates the start time of data replication for APP-4, for which the backup acquisition time is relatively late. The calculation method is the same as that explained with reference to FIG. 7A to FIG. 7F. FIG. 11C shows the result of the calculation (the result of reallocation of data replication period for APP-4). The backup acquisition time for APP-4 is 26:00 and as shown in FIG. 11C, the allocated transfer rate in each time slot of 23:00 to 26:00 is C/2.

The schedule management program 126 can calculate and obtain the start time of data replication (RS) for APP-4 at 23:00 from the backup acquisition time for APP-4, the amount of data to be transferred for APP-4 (3C/2) and the allocated transfer rate in each time slot. Since the data replication period for APP-4 (the start time and the scheduled finish time) has been determined, the schedule management program 126 recalculates the overlap degree and the transfer rate from 22:00 to 23:00.

As understood from FIG. 11C and the foregoing descriptions, the schedule management program 126 assumes that the transfer rate allocated to APP-4 is constant from 25:00 to 26:00 to calculate the start time of data replication. Since the actual data transfer transfers only the data for APP-4 from 25:00 to 26:00 after the data transfer for APP-5, more data for APP-4 is transferred than in the calculation, but the backup scheduling of this example treats it as a margin of error.

The schedule management program 126 may calculate the start time of data replication while allocating the data transfer rate C to APP-4 before 25:20 in the time slot of 25:00 to 26:00.

Next, the schedule management program 126 calculates the start time of data replication for APP-2, for which the backup acquisition time is relatively earlier. FIG. 11D shows the result of the calculation. The backup acquisition time for APP-2 is 25:00 and as shown in FIG. 11C, the allocated transfer rate in the time slot of 24:00 to 25:00 is C/2.

The schedule management program 126 can calculate and obtain the start time of data replication RS for APP-2 is 24:20 from the backup acquisition time for APP-2, the amount of data to be transferred for APP-2 (C/3), and the allocated transfer rate in each time slot. Since the data replication period (the start time and the scheduled finish time) for APP-2 is determined, the schedule management program 126 recalculates the overlap degree and the transfer rate in each time slot from 22:00 to 24:00 as shown in FIG. 11D.

Next, the schedule management program 126 recalculates the start time of data replication for APP-4. This is because, as shown in FIG. 11D, the overlap degree and the allocated data transfer rate in the time slot including the data replication period for APP-4 (23:00 to 24:00) has been changed by scheduling the data replication period for APP-2.

FIG. 11E shows the result of the recalculation. In the time slot of 23:00 to 24:00, the schedule management program 126 allocates a transfer rate of C to APP-4. Accordingly, the result of the recalculation of the start time of data replication for APP-4 is 23:30.

Next, the schedule management program 126 definitely determines the provisionally determined data replication period for APP-1. FIG. 11F shows the result. Specifically, the schedule management program 126 shifts the scheduled time of data replication for APP-1 to 23:30 and accordingly, determines the start time of data replication at 22:50.

The above-described operations are one cycle in the scheduling recalculation. The result is shown in the chart of FIG. 11F. The start time of data replication for APP-1 is set at the earliest time under the conditions where the data replication period for APP 1 continues to data replication period for another application, APP-4, and the start time of the data replication is not earlier than the allowable start time of data replication. Trough the above-described coordination, the shift of the data replication period for APP-1 enables the start time of data replication for APP-4 to shift the most.

In the chart of FIG. 11F, the start time of data replication for APP-4 is 23:30. As shown in FIG. 6, the allowable start time of data replication for APP-4 is 24:00 (00:00) and the start time of data replication is earlier than the allowable start time of data replication. Therefore, the schedule management program 126 determines that the start time of data replication for APP-4 does not satisfy the scheduling requirement and determines to perform the next cycle of scheduling recalculation.

The schedule management program 126 shifts the data replication period for APP-2 in the backup schedule shown in FIG. 11F to an earlier period and performs the same operations as in the above-described first cycle. The schedule management program 126 shifts the data replication period for APP-2 so that the start time of the data replication for APP-2 will be the same as its allowable start time of data replication (22:00). FIG. 11G shows the result.

Since the amount of data to be transferred for APP-2 is C/3 and the overlap degree during 22:00 to 23:00 is 1 (the transferred data is only the data for APP-2), the scheduled finish time of data replication for APP-2 is 22:20. The schedule for APP-2 in FIG. 11G is a provisional schedule.

The schedule management program 126 changes the overlap degree and the allocated transfer rate in each time slot because of the shift of data replication period for APP-2. Since the data replication period for APP-2 has been shifted from the time slot of 24:00 to 25:00, the schedule management program 126 changes the overlap degree in the time slot from 2 to 1 and the data transfer rate to be allocated to an application from C/2 to C.

Next, the schedule management program 126 initializes the schedules of the applications except for the application whose schedule is shifted in the scheduling recalculation, in the latest time slot where the shift of the data replication period for APP-2 causes changes in overlap degree and the time slots earlier than that. In this example, a part of the data replication period for APP-4 is included in these time slots. The data replication period for APP-4 is initialized and reallocated. FIG. 11H shows the result.

The overlap degree in 24:00 to 25:00 is 1 and the transfer rate C is allocated to APP-4. The result of calculation of the start time of data replication for APP-4 by the schedule management program 126 is 24:00.

Next, the schedule management program 126 shifts the data replication periods for APP-1 and APP-2 to later times. FIG. 11I shows the result. The scheduled finish time of data replication for APP-1 is the same as the start time of data replication for APP-4 and the scheduled finish time of data replication for APP-2 is the same as the start time of data replication for APP-1. The start time of data replication for APP-1 is 23:20 and the start time of data replication for APP-2 is 23:00.

As described above, the method of shifting the data replication period for APP-2 in the second cycle is the same as that for APP-1 in the first cycle. The start time of data replication for APP-2 is set at the time earliest possible under the conditions in which the data replication period continues to the data replication period for another application, APP 1, and the start time of data replication is not earlier than the allowable start time of data replication.

In this backup scheduling, the start time of data replication for APP-4 is 24:00 and the allowable start time of data replication therefore is also 24:00 (00:00) as shown in FIG. 6. Accordingly, the start time of data replication for the application 4 is the same as the allowable start time of data replication, satisfying the scheduling requirements. In this backup schedule, all of the start times of data replications satisfy the scheduling requirements and so, the schedule management program 126 terminates the scheduling recalculation.

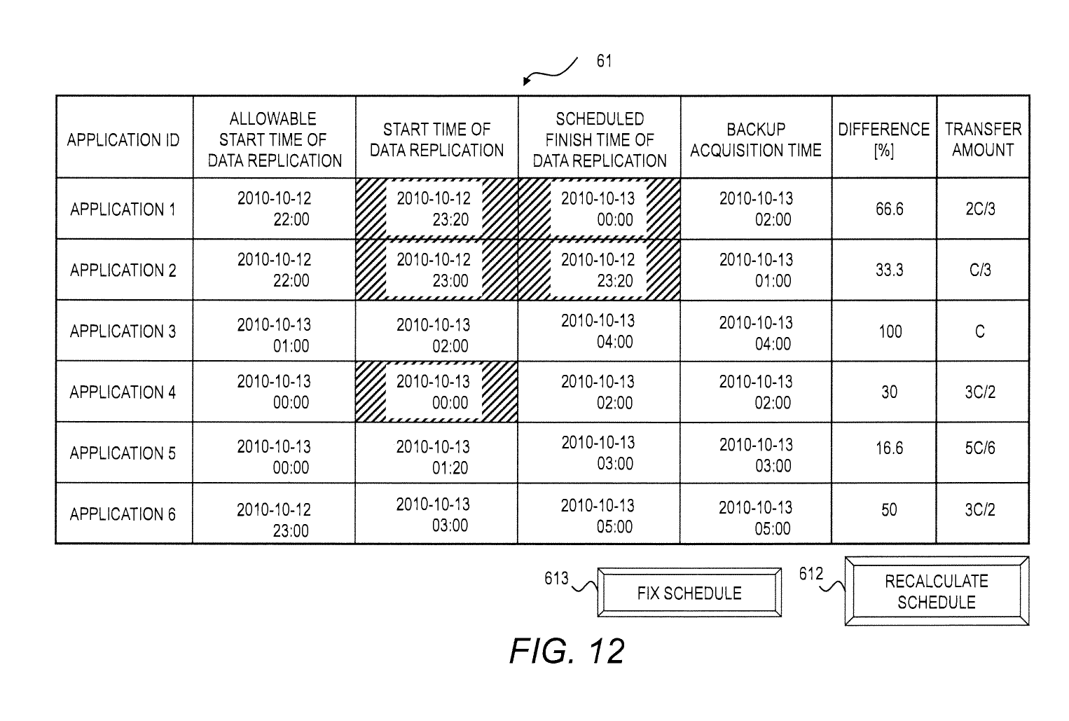

FIG. 12 is a schedule table 61 displaying the result of the foregoing scheduling recalculation. That is to say, the schedule table 61 of FIG. 12 corresponds to the schedule chart of FIG. 11I. In FIG. 12, fields changed from the table of FIG. 8 by the scheduling recalculation are hatched.

The user checks the result of scheduling through the schedule table 61 displayed by the browser program 135 and if no problem is found in the backup schedule, the user selects the button 613 for fixing the schedule with the input apparatus 131. Through this operation, the backup schedule is fixed. The schedule management program 126 may display the schedule confirmation image for the user after selection of the schedule fixing button 613 through the browser program 135.

In the above example, the schedule management program 126 determines the sequence of selecting applications to change their data replication periods in the scheduling recalculation in accordance with preset rules. Specifically, it selects applications in order from the application with the highest priority (likely to be most contributable) depending on the overlap pattern of data replication periods. Unlike this, the schedule management program 126 may change the data replication period for the application designated by the user.

For example, on the screen of the schedule table 61 shown in FIG. 8, the user selects an application to change the data replication period in a scheduling recalculation. The schedule management program 126 advances the data replication period for the designated application.

In a preferred configuration, the schedule management program 126 displays the records of applications in need of change and coordinatable applications on the screen of the schedule table 61 in a different manner to support the user's reset operation. The user can select a coordinatable application without difficulty.

In the foregoing example, the user selects scheduling recalculation to the schedule table 61 shown in FIG. 8 (the table indicating the result of the first scheduling calculation). Unlike this example, the user may change the data inputted by oneself. Specifically, the user resets the allowable start time of data replication for an application for which the start time of data replication is earlier than the allowable start time of data replication, the application 4, according to the backup schedule in the first scheduling (the schedule table in FIG. 8).

For visual support to the user, it is preferable that the schedule table 61 in FIG. 8 display the records of applications which do not satisfy the scheduling requirements in a manner different from the one for the records of the other applications, for example, in a different color.

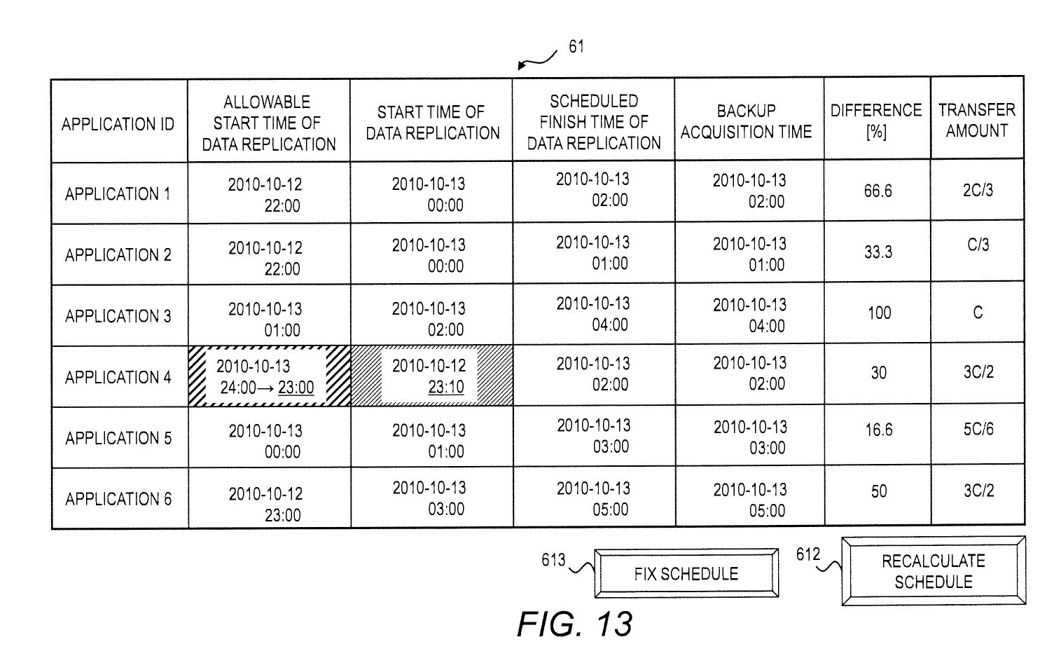

FIG. 13 shows an example of resetting the allowable start time of a data replication by the user. In FIG. 13, the allowable start time of data replication for the application 4 is changed from 24:00 to 23:00. In the schedule, the start time of data replication for the application 4 is 23:10, which satisfies the scheduling requirements.

Thereafter, the user selects the schedule fixing button 613 and the schedule management program 126 fixes the backup schedule in accordance with the selection. The user may select the schedule fixing button 613 without resetting the allowable start time of data replication. The fixed backup schedule is the same as the backup schedule where the allowable start time of data replication is reset.

The result of the scheduling recalculation satisfies the scheduling requirements and all of the start times of data replications are the same as or later than the allowable start times of data replication. Rescheduling, however, may not allow the scheduling requirements to be satisfied. That is to say, even if the schedule is recalculated, the schedule management program 126 may not be able to change any of the start times of data replication to be the same or later than the allowable start times of data replication.

In such a case, the schedule management program 126 provides the user with two choices. If the start times of data replications in the backup schedule are acceptable, the user may select the backup schedule as the definitive schedule like the operations explained with reference to FIG. 13, even though it does not satisfy the scheduling requirements.

In the other choice, the user changes the values of user-specified items in one or more applications and then instructs the schedule management program 126 to recalculate the schedule. In this example, the user-specified items are backup acquisition time and allowable start time of data replication. The user changes either one or both of them in one or more applications and then, instructs the schedule management program 126 to recalculate the schedule.

The schedule management program 126 displays the records of applications in need of change and applications concerned in a manner different from that for the other records. This configuration can show the user applications which can effectively delay the start time of data replication for the application in need of change.

In the above description, an example of volume backup scheduling for six applications has been explained. Hereinafter, a procedure of scheduling by the schedule management program 126 will be described with reference to flowcharts.

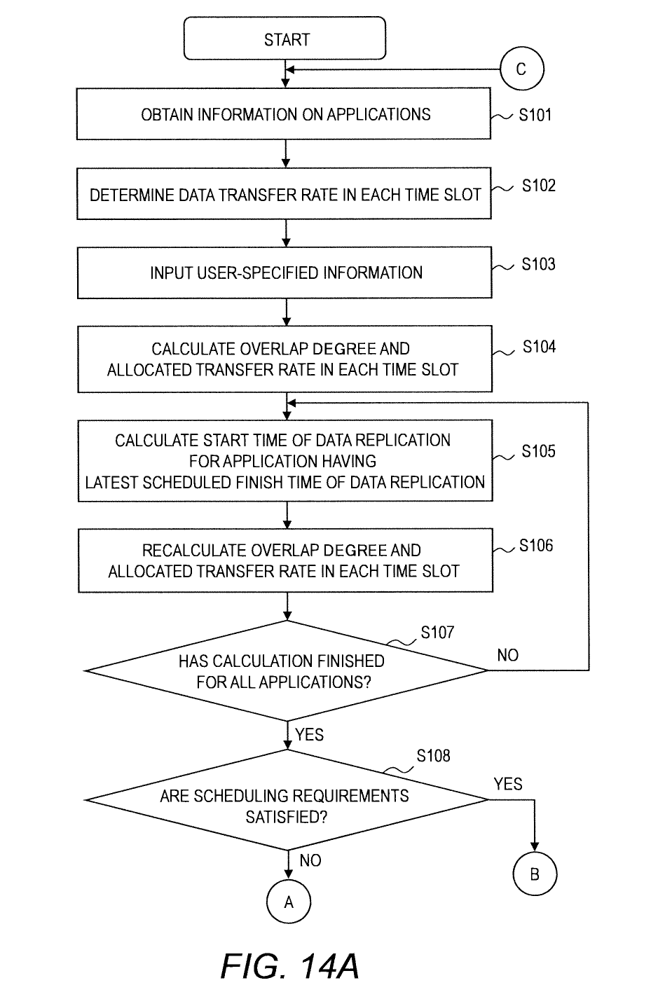

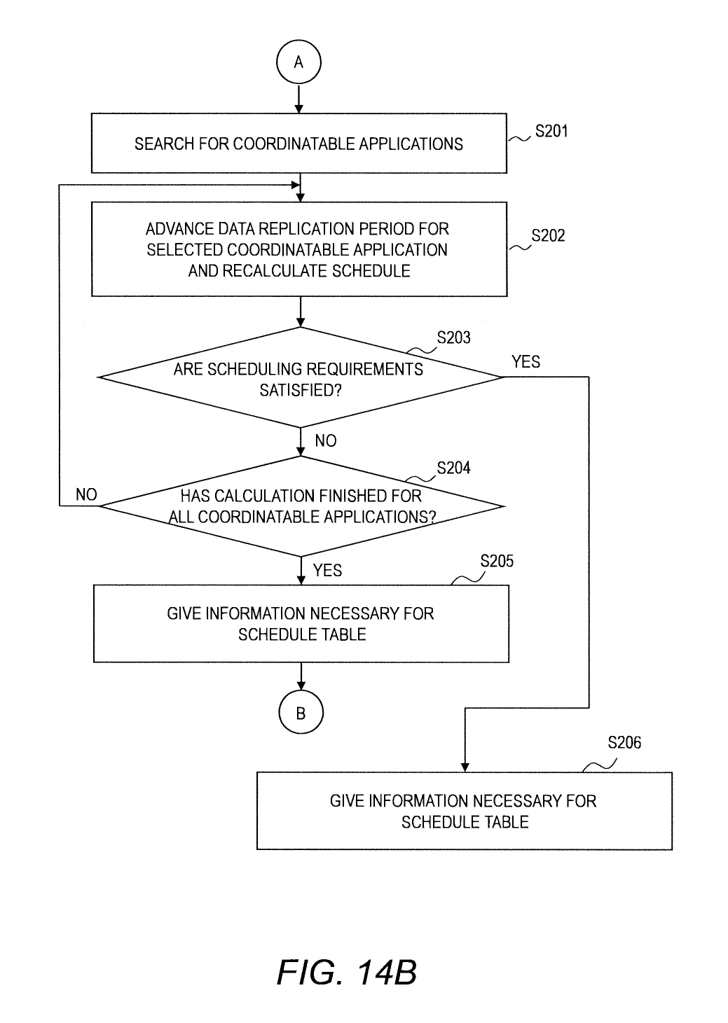

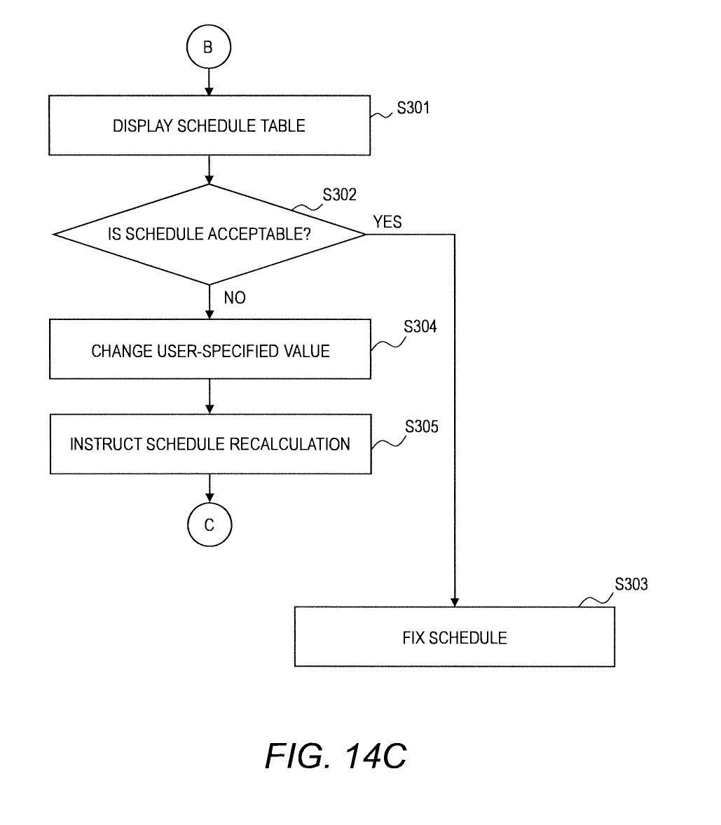

As shown in the flowchart of FIG. 14A, the schedule management program 126 obtains application information from the pair management programs 114 in the business host servers 11a and 11b (S101). The application information is information on each application to be stored in a difference management table and a performance table. The connector C connects from the flowchart of FIG. 14C. The flowchart of FIG. 14C will be described later.

Next, the schedule management program 126 determines the data transfer rates in the scheduling from the performance information on the storage systems 14a and 14b (S102). The details of this step will be described later.

Next, the user inputs information to be specified for scheduling to the schedule table 61 created by the schedule management program 126 (S103). Specifically, the schedule management program 126 gives information for creating image data of the schedule table 61 (information composed of values obtained from the difference management table and the performance table and stored by the schedule management program 126 in the memory) to the GUI program 127. The GUI program 127 transfers the image data of the schedule table 61 to the client 13.

The browser program 135 in the client 13 displays the image on the monitor 134. The user inputs the allowable start time of data replication and the backup acquisition time for each application with the input apparatus 131.

The schedule management program 126 calculates an overlap degree and an allocated transfer rate (provisional values as the initial values) in each time slot as exemplified in FIG. 7A from the allowable start times of data replications and the backup acquisition times specified by the user and the data transfer capability in each time slot (S104). In calculating the overlap degrees, the schedule management program 126 assumes that the data replication period for each application starts at an infinite time before the start time of the backup job.

Next, the schedule management program 126 executes the initial scheduling calculation (calculation before scheduling recalculation). Specifically, the schedule management program 126 selects an application (data replication period) for which the backup acquisition time (scheduled finish time of data replication) is the latest from the applications for which the data replication periods (the start times of data replications) have not been determined yet to calculate the start time of data replication (data replication period) (S105).

In this example, the backup acquisition time is the specified finish time of data replication; the schedule management program 126 makes the scheduled finish time of data replication to be the same as the backup acquisition time. The schedule management program 126 can calculate a period length required for data transfer from the transfer amount for the application and the allocated transfer rate in each time slot. The schedule management program 126 obtains the start time of data replication by deducting the obtained period length from the backup acquisition time (refer to FIG. 7B to FIG. 7F).

When the schedule management program 126 determines the data replication period (calculates the start time of data replication) for one application, it recalculates and updates the overlap degrees and the transfer rates (S106). Since the application for which the start time of data replication and the scheduled finish time of data replication are calculated does not replicate data at any time except for the data replication period, the schedule management program 126 deducts 1 from the overlap degree in each time slot before the start time of data replication to update the overlap degrees and the allocated transfer rates.

After calculating the start time of data replication for the selected application and recalculating the overlap degrees and allocated transfer rates, the schedule management program 126 determines whether any uncalculated application remains or not (S107). If some uncalculated application remains (NO at S107), the schedule management program 126 returns to S105.

If scheduling for all applications is finished (YES at S107), the schedule management program 126 determines whether the scheduling requirements are satisfied or not (S108). Specifically, the schedule management program 126 determines whether all start times of data replications are the same as or later than the specified allowable start times of data replications. If the scheduling requirements are satisfied (YES at S108), the schedule management program 126 proceeds to the flowchart of FIG. 14C via the connector B. The flowchart of FIG. 14C will be described later.

If the scheduling requirements are not satisfied (NO at S108), the schedule management program 126 proceeds to the flowchart of schedule recalculation illustrated by FIG. 14B via the connector A. In the flowchart of FIG. 14B, the schedule management program 126 searches for coordinatable applications for an application for which the start time of data replication is earlier than its allowable start time of data replication (application in need of change) (S201). The schedule management program 126 can find coordinatable applications by a method explained with reference to FIG. 10.

The schedule management program 126 selects an application from the coordinatable applications in accordance with a predetermined rule and recalculates the backup schedule while temporarily shifting the start time of data replication for the application to an earlier time (to determine a provisional data replication period), which is the allowable start time of data replication in a preferred example. (S202).

The application to be selected is, for example, an application which is most contributable or is estimated to be most contributable, as described previously. Depending on the design, the schedule management program 126 may shift the data replication periods for some or all of the coordinatable applications to earlier periods to recalculate the schedule.

The schedule management program 126 determines whether all the data replication periods (the start times of data replications) satisfy the scheduling requirements as a result of the recalculation at S202 (S203). If the scheduling requirements are not satisfied (NO at S203), the schedule management program 126 determines whether schedules are recalculated for all of the coordinatable applications (S204). If any coordinatable application remains (NO at S204), the schedule management program 126 returns to S202.

If the scheduling requirements are satisfied in all of the applications at S203 (YES at S203), the schedule management program 126 gives information necessary for creating a schedule table to the GUI program 127 (S206). The GUI program 127 creates an image data of the schedule table and transmits it to the client 13. The browser program 135 displays the schedule table on the monitor 134.

When the user selects the schedule fixing button 613, the backup schedule is fixed. The user may change the allowable start time of data replication or the backup acquisition time for any of the applications to instruct another scheduling to the schedule management program 126.

In the meanwhile, if the scheduling requirements are not satisfied (NO at S203) but scheduling recalculation for all of the coordinatable applications (YES at S204), the schedule management program 126 gives information necessary for creating a schedule table to the GUI program 127 (S205). The process moves to the flowchart of FIG. 14C via the connector B.

The flowchart of FIG. 14C illustrates changing information specified by the user. The GUI program 127 creates an image data of a schedule table and transmits it to the client 13. The browser program 135 displays the schedule table 61 on the monitor 134 (S301).

The backup schedule of the displayed schedule table 61 does not satisfy the scheduling requirements. In other words, the backup schedule includes a record (application) in which the start time of data replication is prior to the allowable start time of data replication.

If the displayed schedule is acceptable (YES at S302), the user selects the schedule fixing button 613 to fix the backup schedule (S303). If the displayed schedule is not acceptable (NO at S302), the user changes specified value(s) of the allowable start time of data replication and/or the backup acquisition time for any application in the schedule table 61 (S304) to instruct the schedule management program 126 on rescheduling (S305).

The instruction of rescheduling is transferred from the browser program 135 to the schedule management program 126. The schedule management program 126 returns to the flowchart of FIG. 14A via the connector C and executes the process in the flowchart shown in FIG. 14A using the updated information specified by the user.

As described above, the schedule table of a backup schedule which does not satisfy the scheduling requirements displays the records of applications in need of change and applications concerned in a distinguishing manner from that for the records of the other applications. This configuration informs the user of the applications which are likely to contribute to creation of a backup schedule satisfying the scheduling requirements if user specified items thereof are changed.

Hereinafter, tables to be used by the schedule management program 126 and the processes to be performed by the schedule management program 126 using the tables will be described. The schedule management program 126 creates and manages all of the tables held by the management server 12. As shown in FIG. 5, the management server 12 includes a difference history table 251, a difference management table 252, a performance history table 253, a performance table 254, and a schedule management table 255. In each table, time information is indicated by time and date.

As previously described, the data structure of information used by the schedule management program 126 is not limited and the information may have any data structure. For example, the tables 251 to 255 in the following explanations may be configured with different number of tables and may have structures different from the table structures exemplified by FIG. 15 to FIG. 19.

For example, information for managing the schedule may have a data structure different from that of the schedule management table 255; for example, it may additionally includes columns, omit a part of the columns, or divide it into a plurality of tables.

FIG. 15 exemplifies a difference history table 251. FIG. 15 shows only a part of the records in the difference history table 251. The schedule management program 126 creates and manages the difference history table 251. The difference history table 251 holds the history of the value of difference [%] between each copy pair. A value in a field of the difference is a difference at the time when a data replication is started in a backup job.

The difference history table 251 includes columns of application ID, copy pair ID, start time and date of data replication, and difference. The application ID is identification information on applications and the copy pair ID is identification information on copy pairs. In this example, the identification information is indicated with IDs, but identifiers or names are identification information and these may be replaced with one another. The same applies to the other information in this embodiment.

The schedule management program 126 can obtain information to be stored in the difference history table 251 from either one of the storage systems 14a and 14b. Specifically, a pair management program 114 provides information to be stored in the difference history table 251 responsive to a request from the schedule management program 126.

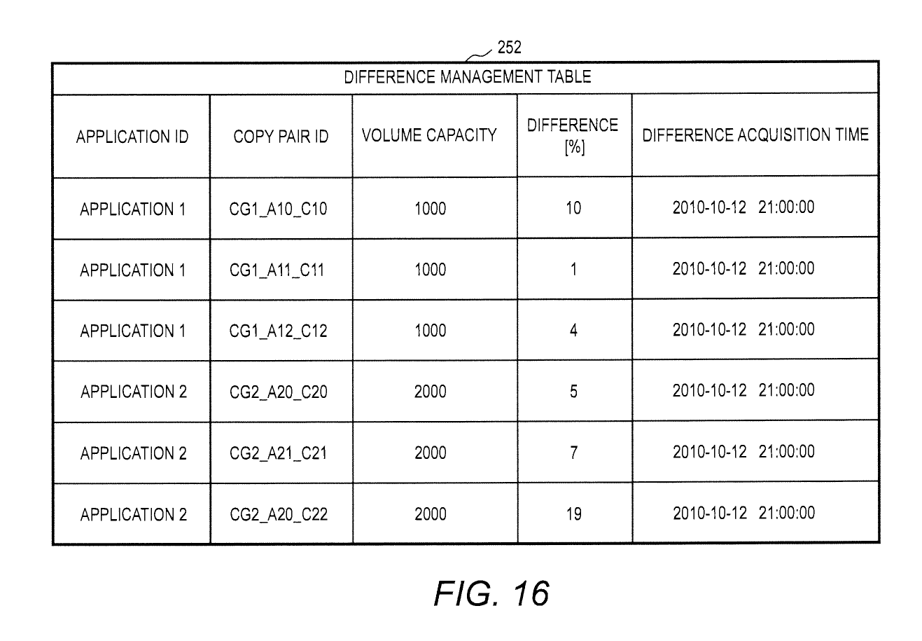

FIG. 16 exemplifies a difference management table 252. FIG. 16 shows a part of the records in the difference management table 252. The schedule management program 126 creates and manages the difference management table. The difference management table 252 holds the value of the latest difference [%] between each copy pair. The schedule management program 126 monitors the difference between each copy pair and periodically stores the difference value in the difference management table 252. For example, the schedule management program 126 updates the difference management table 252 every 10 minutes.

The difference management table 252 contains attribute values of information on application IDs, copy pair IDs, the volume capacity (the capacity of one volume) for each copy pair, difference between each copy pair [%], and record acquisition times and dates. A record acquisition time and date indicates the time and date when the schedule management program 126 obtains information on the record. The schedule management program 126 can obtain the information except for the record acquisition time and date from the pair management program 114 of the storage system including primary volumes.

As previously described, backup scheduling is performed several hours before the actual backup job starts. Alternatively, the same backup schedule may be kept to be used for a several days or several weeks. The schedule management program 126 uses estimated data transfer amount for each application in backup scheduling.

For example, the schedule management program 126 may use the difference values in the last backup job stored in the difference history table 251 as the estimated values. The schedule management program 126 may use statistics of the difference values.

In this example, three copy pairs are allocated to an application 1. The schedule management program 126 can calculate the estimated data transfer amount for the application 1 in backup scheduling using the capacities of the copy pairs allocated to the application 1 in the difference management table 252 and the difference values of the copy pairs in the difference history table 251.

The schedule management program 126 monitors the differences between copy pairs (the actual data transfer amounts) and, if some monitoring value satisfies predetermined alert requirements compared to the estimated value so that the schedule management program 126 expects that the actual value of the data transfer amount will be significantly distant from the estimated value, it creates an alert to notify the user of it. For example, the schedule management program 126 creates an alert including the information on the current difference value and transmits an image data of the alert to the client 13 via the GUI program 127. The client 13 displays the alert on its monitor 134.

Through this configuration, the schedule management program 126 can notify the user that a data replication for some application in the backup job might not be finished by the backup acquisition time with high probability. The user may instruct the schedule management program 126 to reschedule the backup job responsive to the alert.

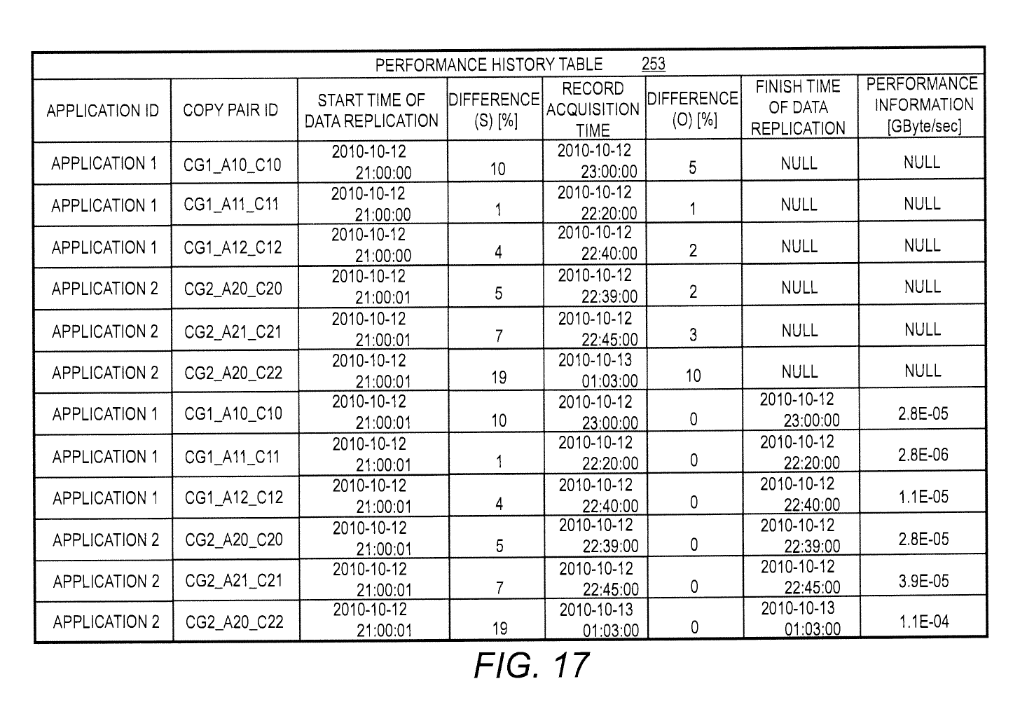

FIG. 17 exemplifies a performance history table 253. FIG. 17 shows a part of the records in the performance history table 253. The performance history table 253 stores history of performance of data transfer (data replication) between the storage systems in data replication between each copy pair.

In this example, the performance history table 253 contains attribute values of application IDs, copy pair IDs, start times and dates of data replications, differences at the start times of data replications (differences (S)), record acquisition times and dates, differences at the times and dates of record acquisition (differences (O)), finish times and dates of data replications, and performance information [GByte/second]. The fields of the finish times and dates of data replications for the records for which the data replications have not been finished store NULL.

The schedule management program 126 creates and manages the performance history table 253. For example, the schedule management program 126 can obtain information to be stored in the performance history table 253 from the pair management program 114 of the storage system 14a. Difference between a copy pair keeps decreasing from the start of a data replication toward the end of the data replication. The performance history table 253 stores difference values at a plurality of times from the start to the end of the data replication (indicated by the record acquisition times (times and dates)) in each data replication.

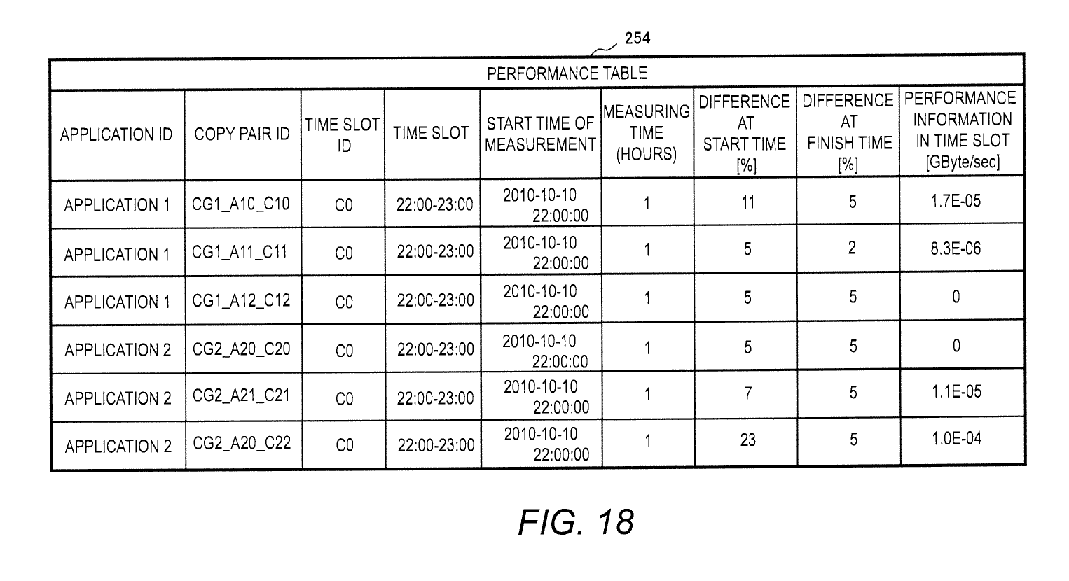

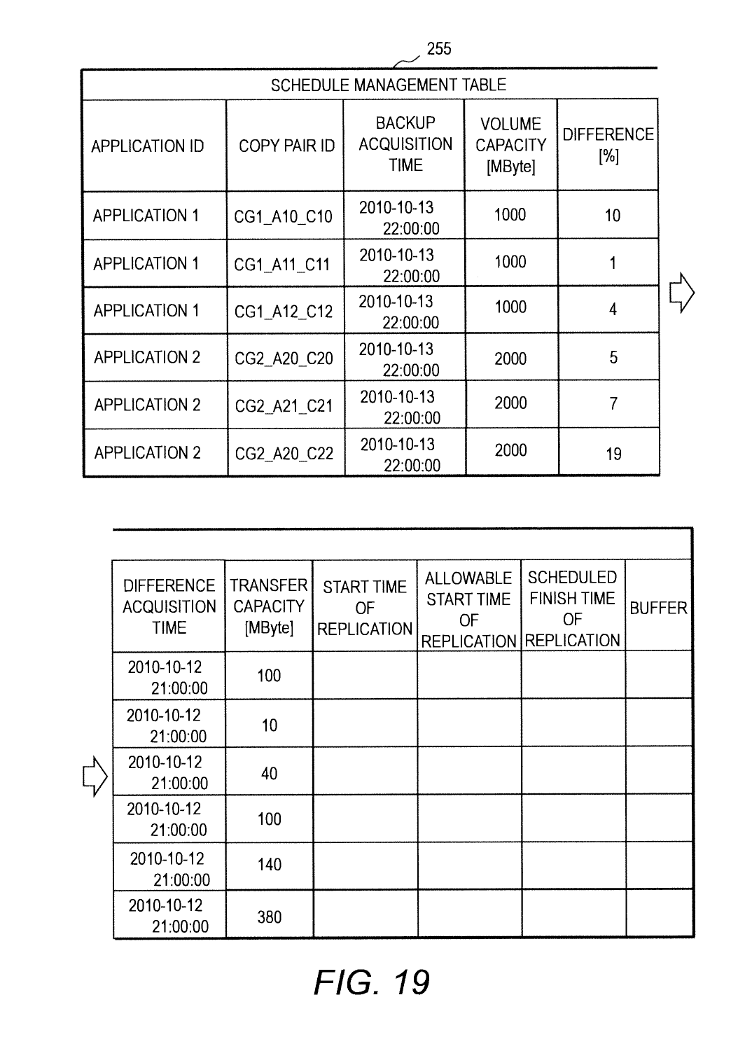

FIG. 18 exemplifies a performance table 254. FIG. 18 shows only a part of the records. The performance table 254 stores information for the schedule management program 126 to determine the data transfer rate applied to backup scheduling.

In the example of FIG. 18, the performance table 254 contains attribute values of application IDs, copy pair IDs, time slot identification information, indication of times for time slots, start times of performance measurements, differences at the start times of performance measurements, differences at the finish times of performance measurements, and performance information in time slots [GByte/second].

Although the performance table 254 shows only the time slot C0 from 22:00 to 23:00, the time period for a backup window is divided into periods of one hour in this example, so different time slot identification information is assigned to each time slot.

The schedule management program 126 can create the performance table 254 from the information in the performance history table 253 and manages it. The performance history table 253 holds one or more difference values in each time slot in each data replication. The schedule management program 126 can calculate or determine the difference at the start and the difference at the end of each time slot from those difference values.

The performance table 254 contains a plurality of records including the same time slot. Specifically, the performance table 254 contains a plurality of records having the fields of the same time slot Ci but having different copy pair IDs and/or different dates (start times and dates of measurements).

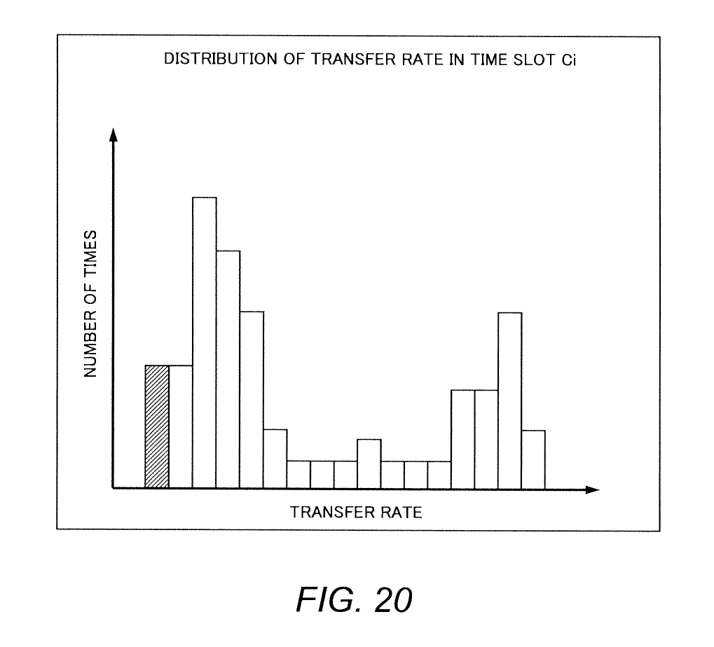

FIG. 20 schematically illustrates an example of distribution of data transfer rate (data replication performance) in a certain time slot Ci. In the graph of FIG. 20, the X axis represents transfer rate and the Y axis represents the number of times (the number of records in the performance table 254). As shown in the distribution of FIG. 20, the data transfer rate in the time slot Ci varies with system conditions.

The schedule management program 126 can calculate the value of the data transfer rate to be used in scheduling from the value of the data transfer rate in the time slot stored in the performance table 254. For example, the schedule management program 126 can use the minimum transfer rate in each time slot as the transfer rate in the time slot in scheduling. This configuration allows the data replication to finish definitively by the backup acquisition time. The schedule management program 126 may use the average value of the transfer rates in the time slot as the transfer rate in the time slot in scheduling.

In the case of using a transfer rate common to all of the time slots instead of determining a transfer rate for every time slot, the schedule management program 126 may use the lowest transfer rate in the statistics in the all time slots as the transfer rate for all of the time slots in scheduling. For more precise scheduling, it is preferable to determine transfer rates for individual time slots from statistics.

As described above, the schedule management program 126 calculates a backup schedule (start times of data replications) using the amount of data to be transferred in the backup job (differences between copy pairs) and the data transfer rate (data replication capabilities of the storage systems). The schedule management program 126 refers to the difference management table 252 and the difference history table 251 to obtain information on the amount of data to be transferred and refers to the performance table 254 to obtain information on the data transfer rate.

FIG. 19 exemplifies a schedule management table 255. The schedule management program 126 creates the schedule management table 255. The schedule management program 126 stores the result of scheduling a backup job with reference to the information in the difference management table 252, the performance table 254, and the values inputted by the user, in the schedule management table 255.

In the example of FIG. 19, the schedule management table 255 contains attribute values of application IDs, copy pair IDs, backup acquisition times and dates, the volume capacities of copy pairs (capacities of the primary volumes), the differences between the volumes forming the copy pair [%], the record acquisition times and dates, the amounts of data to be transferred calculated from the differences between the volumes and the volume capacities, the start times and dates of data replications, the allowable start times and dates of data replications, and buffering periods.

The method of obtaining the information stored in the schedule management table 255 has already been explained; accordingly, explanation is omitted here. In this example, the user may specify a buffering time in addition to a backup acquisition time. The schedule management program 126 can obtain information for a schedule table to be provided to the user from the information in the schedule management table 255.

As set forth above, this invention has been described in detail with reference to the accompanying drawings. This invention, however, is not limited to the specific configurations in the descriptions but includes various modifications and equivalent configurations within the scope of the appended claims. In this embodiment, the information stored in data storage areas does not depend on the data structure but may be expressed in any data structure. For example, a data structure appropriately selected from table, list, database, and queue can store the information.

A program is executed by a processor to perform predetermined jobs using a storage apparatus and a communication port (communication device). Accordingly, the explanations in this embodiment having the subjects of “program” may be replaced with those having the subjects of “processor”. A job executed by a program is a job executed by the computer or the computer system on which the program runs. The processor works in accordance with a program to work as operation parts for implementing functions. The computer and the computer system are an apparatus and a system having those operation parts.

At least a part of the programs may be provided with dedicated hardware. Programs may be installed in each computer through a program distribution server or a computer-readable non-transitory storage medium and may be stored in a non-volatile storage area in each computer. At least a part of the settings made by the user through an input and output device in this embodiment may be executed by a program.

The management server 12 includes input and output devices and the user may input or output necessary information with the input and output devices. The input and output devices are typically a mouse, a keyboard, and a monitor, but may be different devices. The same applies to the client 13 and the business host servers 11a and 11b.

### REFERENCE SIGNS LISTS

11a, 11b Business host servers

12 Management server

13 Client

14a, 14b Storage systems

15 Management network

16 Data network

61 Schedule Table

111 Network interface

112 Processor

113 Business applications

114 Pair management program

115 Secondary storage apparatus

116 Primary storage apparatus

117 Bus

121 Network interface

122 Processor

123 Primary storage apparatus

124 Bus

125 Secondary storage apparatus

126 Schedule management program

127 GUI program

131 Input apparatus

132 Processor

133 Network interface

134 Monitor

135 Browser program

136 Primary storage apparatus

137 Secondary storage apparatus

141a, 141b Controllers

142a Primary volume

143b Secondary volume

251 Difference history table

252 Difference management table

253 Performance history table

254 Performance table

255 Schedule management table

1. A computer system comprising:
a first storage system for providing a plurality of applications with volumes;
a second storage system which is coupled to the first storage system and stores backup volumes of the volumes; and
a management system which is coupled to the first storage system and the second storage system and schedules data replications of the volumes,
wherein:
the management system determines respective scheduled finish times of data replications for the plurality of applications; and
the management system determines individual start times of the data replications for the plurality of applications from the respective scheduled finish times of data replications and respective amounts of data to be transferred for the plurality of applications, using a data transfer rate between the first storage system and the second storage system and an overlap degree of data replication periods of the plurality of applications.

2. A computer system according to claim 1, wherein the management system performs rescheduling to adjust a data replication period for a first application for which a start time of a data replication is earlier than a predetermined allowable start time.

3. A computer system according to claim 2, wherein, in the rescheduling, the management system selects a second application for which a data replication period overlaps with the data replication period for the first application and coordinates the data replication periods for the first application and the second application.

4. A computer system according to claim 3, wherein:
the management system selects data replication periods which overlap with the data replication period for the first application one by one and sequentially coordinates the selected data replication periods and the data replication period of the first application; and
if the coordinated start time of the data replication for the first application is the same as or later than the allowable start time of the data replication, the management system terminates the rescheduling.

5. A computer system according to claim 4, wherein:
the management system refers to preliminarily defined information on a plurality of overlap patterns of data replication periods to determine individual overlap patterns of the data replication period for the first application with the overlapping data replication periods; and
the management system selects a data replication period with the highest priority among the plurality of overlapping data replication periods as the data replication period to be coordinated in accordance with respective priority levels assigned to the plurality of overlap patterns.

6. A computer system according to claim 5, wherein the management system determines the start time of the data replication for the second application to be the earliest time among the times which are the same as and later than the allowable start time of the data replication for the second application under a condition where the data replication period for the second application continues to a data replication period of a different application.

7. A computer system according to claim 6, wherein:
the management system stores user-specified allowable start times of data replications and finish times of data replications for the plurality of applications;
the management system determines individual scheduled finish times of data replications for the plurality of applications to be the same as or earlier than the respective specified finish times of data replications for the plurality of application,
the management system displays a schedule table including the determined start times of data replications for the plurality of applications using a display apparatus, and
the management system performs the rescheduling in response to a user input to the schedule table.

8. A computer system according to claim 7, wherein:
the management system displays information indicating that a rescheduled start time of the data replication for the first application is earlier than the allowable start time of the data replication using the display apparatus; and
the management computer performs a second rescheduling using an allowable start time of data replication and/or a specified finish time of data replication for one of the plurality of applications changed by the user on the displayed information.

9. A computer system according to claim 8, wherein the management system sequentially determines the start times of data replications of the plurality of applications in order from the application for which the determined scheduled finish time of the data replication is the latest.

10. A computer system according to claim 9, wherein, in the determination of the start times of the data replications:
the management computer determines provisional data replication periods having predetermined time lengths from the determined scheduled finish times of the respective data replications for the plurality of applications,
the management computer determines a value of a provisional overlap degree of the provisional data replication periods in each time slot;
the management computer sequentially selects applications from the plurality of applications to determine the start times of the data replications and, in each of the determinations of the start times of the data replications, the management computer updates the provisional values of the overlap degrees in the time slots earlier than the determined start time of the data replication

11. A computer system according to claim 10, wherein the management system determines the data transfer rate to be used in the scheduling of data replications from a history of data transfers between the first storage system and the second storage system.

12. A method of scheduling data replications for backing up from a first storage system providing a plurality of applications with volumes to a second storage system, the method comprising:
determining, by a management system for managing the first storage system and the second storage system, scheduled finish times of respective data replications for the plurality of applications to store the determined scheduled finish times of the respective data replications in schedule management information in a data storage apparatus;
determining, by the management system, amounts of data to be transferred in the respective data replications for the plurality of applications to store the amounts of data to be transferred in the schedule management information; and
determining, by the management system, start times of the respective data replications for the plurality of applications from the scheduled finish times of the respective data replications for the plurality of applications and the amount of data to be transferred, using a data transfer rate between the first storage system and the second storage system and an overlap degree of data replication periods for the plurality of applications.

13. A method of scheduling data replications according to claim 12, further comprising: rescheduling, by the management system, the replications of the data to adjust a data replication period for a first application for which a start time of a data replication is earlier than a predetermined allowable start time of the data replication.

14. A method of scheduling data replications according to claim 12, further comprising: sequentially determining the start times of data replications of the plurality of applications in order from the application for which the predetermined scheduled finish time of the data replication is the latest.

15. A computer-readable non-transitory storage medium for storing codes executed by a management system for managing a first storage system providing a plurality of applications with volumes and a second storage system to schedule data replications for backing up from the first storage system to the second storage system, the scheduling comprises:
determining scheduled finish times of respective data replications for the plurality of applications to store the determined scheduled finish times of the respective data replications in schedule management information in a data storage apparatus;
determining amounts of data to be transferred in the respective data replications for the plurality of data replications to store the amounts of data to be transferred in the schedule management information; and
determining start times of the respective data replications for the plurality of applications from the scheduled finish times of the respective data replications for the plurality of applications and the amounts of data to be transferred, using a data transfer rate between the first storage system and the second storage system and an overlap degree of data replication periods of the plurality of applications.
